(19) United States
(12) Patent Application Publication
(10) Pub. No.: US 2024/0072898 A1
(43) Pub. Date: Feb. 29, 2024

(54) OPTICAL FIBER BRANCHING SWITCHING APPARATUS

(71) Applicant: NEC Corporation, Tokyo (JP)

(72) Inventor: Hideo ASADA, Tokyo (JP)

(73) Assignee: NEC Corporation, Tokyo (JP)

(21) Appl. No.: 18/237,463

(22) Filed: Aug. 24, 2023

(30) Foreign Application Priority Data
Aug. 30, 2022 (JP) 2022-136626

(51) Int. Cl. H04B 10/25; G02B 6/02; H04B 10/275; H04Q 11/00

(52) U.S. Cl. CPC H04B 10/2589; G02B 6/02042; H04B 10/275; H04Q 11/0005; H04Q 2011/0024

(57) ABSTRACT

An optical fiber branching switching apparatus that branches and switches a multi-core fiber to a multi-core fiber is provided. Provided is an optical fiber branching switching apparatus including a first optical fiber, a second optical fiber, a third optical fiber, a plurality of fourth optical fibers, a plurality of fifth optical fibers, and a plurality of sixth optical fibers, wherein the first optical fiber is connected to the second optical fiber by using a plurality of the fourth optical fibers, the first optical fiber is connected to the third optical fiber by using a plurality of the fifth optical fibers, and the second optical fiber is connected to the third optical fiber by using a plurality of the sixth optical fibers.

### INCORPORATION BY REFERENCE

This application is based upon and claims the benefit of priority from Japanese patent application No. 2022-136626, filed on Aug. 30, 2022, the disclosure of which is incorporated herein in its entirety by reference.

### TECHNICAL FIELD

The present disclosure relates to an optical fiber branching switching apparatus.

### BACKGROUND ART

Patent Literature 1 (International Patent Publication No. WO2017/090600) discloses a communication system in which three or more nodes are included and a multi-core fiber including a plurality of cores in at least some of sections among connections between the nodes is used. A node connected to the multi-core fiber includes a connector performing inserting and branching a signal to a core exclusively allocated for communication between another node and the own node. The connector relays a signal transmitted by a core allocated for communication between other nodes in a multi-core fiber connected to the own node.

Patent Literature 2 (International Patent Publication No. WO2017/090611) discloses a communication system in which three or more nodes are included and a multi-core fiber including a plurality of cores in at least some of sections among connections between the nodes is used. The communication system includes a detection signal output unit that outputs a failure detection signal transmitted by a core included in a multi-core fiber connecting between nodes. In addition, the communication system includes a failure detection unit that determines whether a failure occurs between the nodes, based on a detection result of the failure detection signal.

### SUMMARY

Patent Literatures 1 and 2 are to convert a multi-core fiber into a single fiber by performing fan-in/fan-out. However, an optical fiber branching switching apparatus that branches and switches a multi-core fiber to a multi-core fiber is not disclosed. Therefore, an example object of the present disclosure is to provide an optical fiber branching switching apparatus that branches and switches a multi-core fiber to a multi-core fiber.

According to the present disclosure, it is possible to provide an optical fiber branching switching apparatus that branches and switches a multi-core fiber to a multi-core fiber.

In a first example aspect, an optical fiber branching switching apparatus according to the present disclosure includes:
a first optical fiber; a second optical fiber; a third optical fiber; a plurality of fourth optical fibers; a plurality of fifth optical fibers; and a plurality of sixth optical fibers, wherein
the first optical fiber is connected to the second optical fiber by using a plurality of the fourth optical fibers,
the first optical fiber is connected to the third optical fiber by using a plurality of the fifth optical fibers, and
the second optical fiber is connected to the third optical fiber by using a plurality of the sixth optical fibers.

In a second example aspect, another optical fiber branching switching apparatus according to the present disclosure includes:
a first optical fiber; a second optical fiber; a third optical fiber; a fourth optical fiber; a plurality of fifth optical fibers; a plurality of sixth optical fibers; and a plurality of seventh optical fibers, wherein
the first optical fiber is connected to the second optical fiber by using a plurality of the fifth optical fibers,
the first optical fiber is connected to the third optical fiber by using a plurality of the sixth optical fibers, and
the second optical fiber is connected to the fourth optical fiber by using a plurality of the seventh optical fibers.

In a third example aspect, another optical fiber branching switching apparatus according to the present disclosure includes:
a first optical fiber including a first plurality of cores; a second optical fiber including a second plurality of cores; a third optical fiber including a third plurality of cores; a fourth optical fiber including a fourth plurality of cores;
a first switching apparatus; and a second switching apparatus, wherein
the first plurality of cores are connected to the third plurality of cores,
the second plurality of cores are connected to the fourth plurality of cores, and
the first plurality of cores are connected to the second plurality of cores via the first switching apparatus and the second switching apparatus.

In a fourth example aspect, another optical fiber branching switching apparatus according to the present disclosure includes:
a first optical fiber; a second optical fiber; a third optical fiber; a fourth optical fiber; a fifth optical fiber; a sixth optical fiber; a seventh optical fiber; an eighth optical fiber; a plurality of ninth optical fibers; a plurality of tenth optical fibers; a plurality of eleventh optical fibers; a plurality of twelfth optical fibers;
a first switching apparatus; a second switching apparatus; a third switching apparatus; and a fourth switching apparatus, wherein
the first optical fiber is connected to the sixth optical fiber by using a plurality of the ninth optical fibers,
the second optical fiber is connected to the fifth optical fiber by using a plurality of the tenth optical fibers,
the third optical fiber is connected to the seventh optical fiber by using a plurality of the eleventh optical fibers,
the fourth optical fiber is connected to the eighth optical fiber by using a plurality of the twelfth optical fibers,
a plurality of the ninth optical fibers are connected to a plurality of the eleventh optical fibers via the first switching apparatus and the second switching apparatus, and
a plurality of the tenth optical fibers are connected to a plurality of the twelfth optical fibers via the third switching apparatus and the fourth switching apparatus.

In a fifth example aspect, another optical fiber branching switching apparatus according to the present disclosure includes:
a first optical fiber; a second optical fiber; a third optical fiber; a fourth optical fiber; a fifth optical fiber; a sixth optical fiber; a seventh optical fiber; a plurality of eighth optical fibers; a plurality of ninth optical fibers; a plurality of tenth optical fibers; and a plurality of eleventh optical fibers, wherein
the first optical fiber is connected to the fifth optical fiber by using a plurality of the eighth optical fibers,
the second optical fiber is connected to the fifth optical fiber by using a plurality of the ninth optical fibers,
the third optical fiber is connected to the sixth optical fiber by using a plurality of the tenth optical fibers, and
the fourth optical fiber is connected to the seventh optical fiber by using a plurality of the eleventh optical fibers.

In a sixth example aspect, another optical fiber branching switching apparatus according to the present disclosure includes:
a first optical fiber; a second optical fiber; a third optical fiber; a fourth optical fiber; a plurality of fifth optical fibers; a plurality of sixth optical fibers; a plurality of seventh optical fibers; a plurality of eighth optical fibers;
a first switching apparatus; and a second switching apparatus, wherein
the first optical fiber is connected to the third optical fiber by using a plurality of the fifth optical fibers and a plurality of the sixth optical fibers,
the second optical fiber is connected to the fourth optical fiber by using a plurality of the seventh optical fibers and a plurality of the eighth optical fibers, and
a plurality of the fifth optical fibers are connected to a plurality of the seventh optical fiber via the first switching apparatus and the second switching apparatus.

In a seventh example aspect, another optical fiber branching switching apparatus according to the present disclosure includes:
a first optical fiber; a second optical fiber; a third optical fiber; a plurality of fourth optical fibers; a plurality of fifth optical fibers; a sixth optical fiber; and a seventh optical fiber, wherein
the first optical fiber is connected to the second optical fiber by using a plurality of the fourth optical fibers,
the first optical fiber is connected to the third optical fiber by using a plurality of the fifth optical fibers,
the second optical fiber is connected to the sixth optical fiber, and
the second optical fiber is connected to the seventh optical fiber.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic diagram of an optical fiber branching switching apparatus according to a first example embodiment;

FIG. 2 is a schematic diagram of another optical fiber branching switching apparatus according to the first example embodiment;

FIG. 3 is a schematic diagram of another optical fiber branching switching apparatus according to the first example embodiment;

FIG. 4 is a schematic diagram of another optical fiber branching switching apparatus according to the first example embodiment;

FIG. 5 is a schematic diagram of an optical fiber branching switching apparatus according to a second example embodiment;

FIG. 6 is a schematic diagram of another optical fiber branching switching apparatus according to the second example embodiment;

FIG. 7 is a schematic diagram of another optical fiber branching switching apparatus according to the second example embodiment;

FIG. 8 is a schematic diagram of another optical fiber branching switching apparatus according to the second example embodiment;

FIG. 9 is a schematic diagram of an optical fiber branching switching apparatus according to a third example embodiment;

FIG. 10 is a schematic diagram of the optical fiber branching switching apparatus according to the third example embodiment;

FIG. 11 is a schematic diagram of an optical fiber branching switching apparatus according to a fourth example embodiment;

FIG. 12 is a schematic diagram of the optical fiber branching switching apparatus according to the fourth example embodiment;

FIG. 13 is a schematic diagram of the optical fiber branching switching apparatus according to the fourth example embodiment;

FIG. 14 is a schematic diagram of an optical fiber branching switching apparatus according to a fifth example embodiment;

FIG. 15 is a schematic diagram of another optical fiber branching switching apparatus according to the fifth example embodiment;

FIG. 16 is a schematic diagram of another optical fiber branching switching apparatus according to the fifth example embodiment;

FIG. 17 is a schematic diagram of another optical fiber branching switching apparatus according to the fifth example embodiment;

FIG. 18 is a schematic diagram of an optical fiber branching switching apparatus according to a sixth example embodiment;

FIG. 19 is a schematic diagram of the optical fiber branching switching apparatus according to the sixth example embodiment;

FIG. 20 is a schematic diagram of the optical fiber branching switching apparatus according to the sixth example embodiment;

FIG. 21 is a schematic diagram of an optical fiber branching switching apparatus according to a seventh example embodiment;

FIG. 22 is a schematic diagram of another optical fiber branching switching apparatus according to the seventh example embodiment;

FIG. 23 is a schematic diagram of another optical fiber branching switching apparatus according to the seventh example embodiment;

FIG. 24 is a schematic diagram of another optical fiber branching switching apparatus according to the seventh example embodiment; and

FIG. 25 is a schematic diagram of another optical fiber branching switching apparatus according to the seventh example embodiment.

### EXAMPLE EMBODIMENT

### Example Embodiment

Hereinafter, example embodiments of the present disclosure will be described with reference to the drawings. However, the disclosure according to the claims is not limited to the following example embodiments. In addition, all of configurations described in the example embodiments may not be essential as a means for solving a problem. For clarity of explanation, the following description and the drawings are omitted and simplified as appropriate. In each drawing, the same elements are denoted by the same reference signs, and redundant descriptions are omitted as necessary.

### (Description of Optical Fiber Branching Switching Apparatus According to First Example Embodiment)

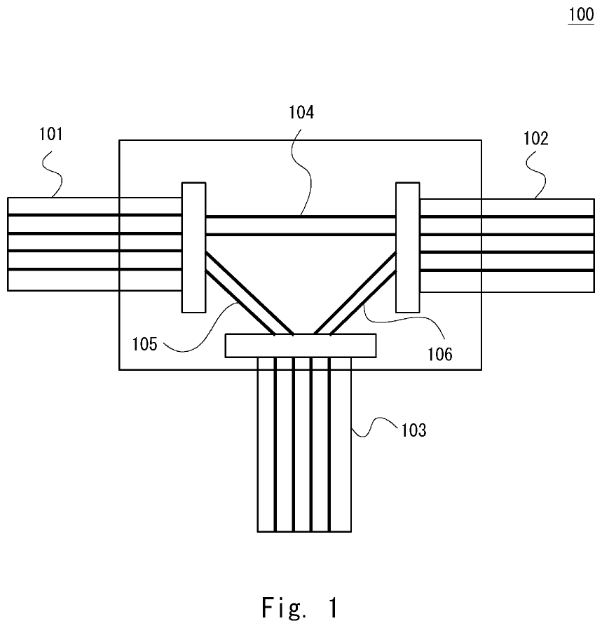

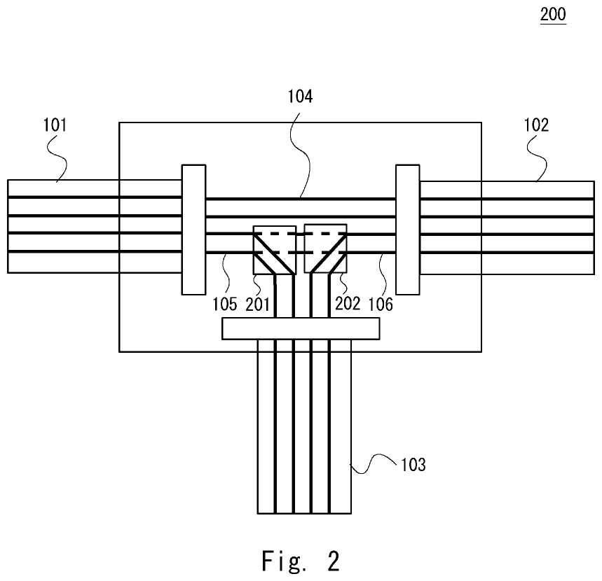

FIG. 1 is a schematic diagram of an optical fiber branching switching apparatus according to a first example embodiment. FIGS. 2 to 4 are schematic diagrams of another optical fiber branching switching apparatus according to the first example embodiment. Referring to FIGS. 1 to 4, an optical fiber branching switching apparatus according to the first example embodiment will be described.

Referring to FIG. 1, an optical fiber branching switching apparatus 100 according to the first example embodiment includes a first optical fiber 101, a second optical fiber 102, a third optical fiber 103, a plurality of fourth optical fibers 104, a plurality of fifth optical fibers 105, and a plurality of sixth optical fibers 106. The optical fiber branching switching apparatus 100 according to the present example embodiment uses a FIFO: fan-in/fan-out device for a multi-core fiber. The first optical fiber 101 is connected to the second optical fiber 102 by using a plurality of the fourth optical fibers 104 via the optical fiber branching switching apparatus 100. The first optical fiber 101 is connected to the third optical fiber 103 by using a plurality of the fifth optical fibers 105 via the optical fiber branching switching apparatus 100. The second optical fiber 102 is connected to the third optical fiber 103 by using a plurality of the sixth optical fibers 106 via the optical fiber branching switching apparatus 100.

The first optical fiber 101 includes a first plurality of cores. The first plurality of cores of the first optical fiber 101 are performed fan-in/fan-out and separated into a plurality of the fourth optical fibers 104 and a plurality of the fifth optical fibers 105 in the optical fiber branching switching apparatus 100. A fan-in/fan-out device for a multi-core fiber is disposed between the first optical fiber 101 and the fourth optical fiber 104. In other words, a longitudinally elongated rectangle indicated between the first optical fiber 101 and the fourth optical fiber 104 serves as the fan-in/fan-out device for a multi-core fiber.

The second optical fiber 102 includes a second plurality of cores. The second plurality of cores of the second optical fiber 102 are performed fan-in/fan-out and separated into a plurality of the fourth optical fibers 104 and a plurality of the sixth optical fibers 106 in the optical fiber branching switching apparatus 100.

A fan-in/fan-out device for a multi-core fiber is disposed between the second optical fiber 102 and the sixth optical fiber 106. A fan-in/fan-out device for a multi-core fiber is disposed between the second optical fiber 102 and the fourth optical fiber 104. In other words, a longitudinally elongated rectangle indicated between the second optical fiber 102 and the fourth optical fiber 104 serves as the fan-in/fan-out device for a multi-core fiber.

The third optical fiber 103 includes a third plurality of cores. The third plurality of cores of the third optical fiber 103 are performed fan-in/fan-out and separated into a plurality of the fifth optical fibers 105 and a plurality of the sixth optical fibers 106 in the optical fiber branching switching apparatus 100. A fan-in/fan-out device for a multi-core fiber is disposed between the third optical fiber 103 and the fifth optical fiber 105. A laterally elongated rectangle indicated between the third optical fiber 103 and the fifth optical fiber 105 serves as the fan-in/fan-out device for a multi-core fiber.

By using the optical fiber branching switching apparatus 100 in this manner, it is possible to branch and switch a multi-core fiber to a multi-core fiber.

Referring to FIG. 2, an optical fiber branching switching apparatus 200 according to the first example embodiment further includes a first switching apparatus 201 and a second switching apparatus 202 in addition to a configuration of the optical fiber branching switching apparatus 100. In the optical fiber branching switching apparatus 200, a plurality of the fifth optical fibers 105 are connected to a plurality of the sixth optical fibers 106 via the first switching apparatus 201 and the second switching apparatus 202.

By using the optical fiber branching switching apparatus 200 in this manner, a multi-core fiber of the first optical fiber 101 can be connected to a multi-core fiber of the second optical fiber 102.

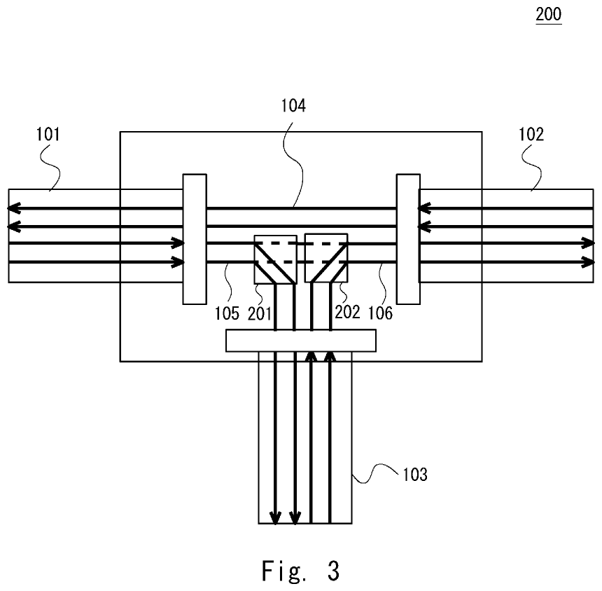

FIG. 3 illustrates, for the optical fiber branching switching apparatus 200 according to the first example embodiment, a direction from which a signal is incident and a direction to which the signal is emitted. As illustrated in FIG. 3, the fourth optical fiber 104 includes a line through which a signal is incident from the second optical fiber 102 and is emitted to the first optical fiber 101. A plurality of the fourth optical fibers 104 transmit a signal in only one direction.

The fifth optical fiber 105 includes a line through which a signal is incident from the first optical fiber 101 and is emitted to the third optical fiber 103. A plurality of the fifth optical fibers 105 transmit a signal in only one direction.

The sixth optical fiber 106 includes a line through which a signal is incident from the third optical fiber 103 and is emitted to the second optical fiber 102. A plurality of the sixth optical fibers 106 transmit a signal in only one direction.

With such a configuration, the first optical fiber 101 being a multi-core fiber can transmit a transmission/reception signal. In addition, the second optical fiber 102 being a multi-core fiber can also transmit a transmission/reception signal. Further, the third optical fiber 103 being a multi-core fiber can also transmit a transmission/reception signal.

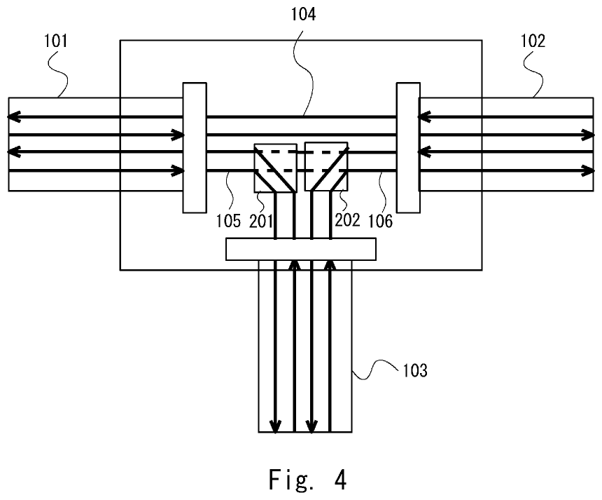

FIG. 4 illustrates, for the optical fiber branching switching apparatus 200 according to the first example embodiment, a direction from which a signal is incident and a direction to which the signal is emitted. As illustrated in FIG. 4, a plurality of the fourth optical fibers 104 include a line through which a signal is incident from the first optical fiber 101 and is emitted to the second optical fiber 102, and a line through which a signal is incident from the second optical fiber 102 and is emitted to the first optical fiber 101. A plurality of the fourth optical fibers 104 transmit a signal in bidirectional. A plurality of the fifth optical fibers 105 include a line through which a signal is incident from the first optical fiber 101 and is emitted to the third optical fiber 103, and a line through which a signal is incident from the third optical fiber 103 and is emitted to the first optical fiber 101. A plurality of the fifth optical fibers 105 transmit a signal in bidirectional. A plurality of the sixth optical fibers 106 include a line through which a signal is incident from the second optical fiber 102 and is emitted to the third optical fiber 103, and a line through which a signal is incident from the third optical fiber 103 and is emitted to the second optical fiber 102. A plurality of the sixth optical fibers 106 transmit a signal in bidirectional. Then, the line of the fifth optical fiber 105 through which a signal is incident from the first optical fiber 101 and is emitted to the third optical fiber 103 is connected to the line of the sixth optical fiber 106 through which a signal is incident from the third optical fiber 103 and is emitted to the second optical fiber 102. The connection is made via the first switching apparatus 201 and the second switching apparatus 202. The line of the fifth optical fiber 105 through which a signal is incident from the third optical fiber 103 and is emitted to the first optical fiber 101 is connected to the line of the sixth optical fiber 106 through which a signal is incident from the second optical fiber 102 and is emitted to the third optical fiber 103. The connection is made via the first switching apparatus 201 and the second switching apparatus 202.

With such a configuration, the first optical fiber 101 being a multi-core fiber can transmit a transmission/reception signal. In addition, the second optical fiber 102 being a multi-core fiber can also transmit a transmission/reception signal. Further, the third optical fiber 103 being a multi-core fiber can also transmit a transmission/reception signal.

### (Description of Optical Fiber Branching Switching Apparatus According to Second Example Embodiment)

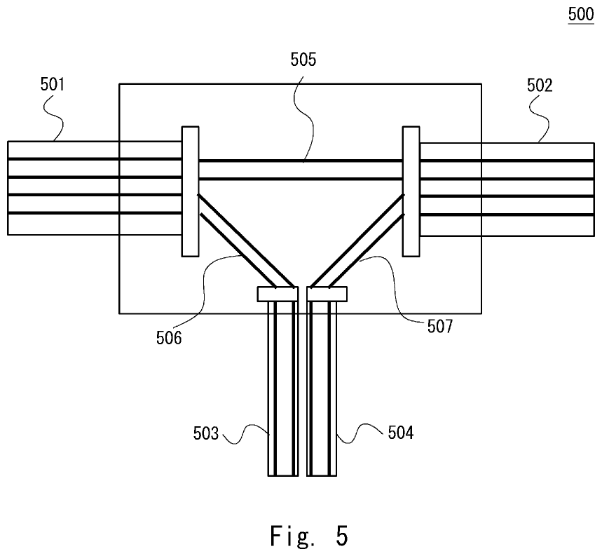

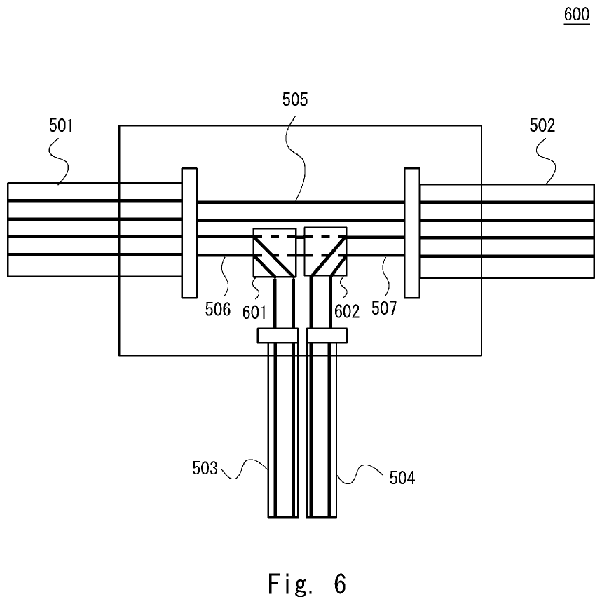

FIG. 5 is a schematic diagram of an optical fiber branching switching apparatus according to a second example embodiment. FIGS. 6 to 8 are schematic diagrams of another optical fiber branching switching apparatus according to the second example embodiment. Referring to FIGS. 5 to 8, an optical fiber branching switching apparatus according to the second example embodiment will be described.

Referring to FIG. 5, an optical fiber branching switching apparatus 500 according to the second example embodiment includes a first optical fiber 501, a second optical fiber 502, a third optical fiber 503, a fourth optical fiber 504, a plurality of fifth optical fibers 505, a plurality of sixth optical fibers 506, and a plurality of seventh optical fibers 507.

The first optical fiber 501 is connected to the second optical fiber 502 by using a plurality of the fifth optical fibers 505 via the optical fiber branching switching apparatus 500. The first optical fiber 501 is connected to the third optical fiber 503 by using a plurality of the sixth optical fibers 506 via the optical fiber branching switching apparatus 500. The second optical fiber 502 is connected to the fourth optical fiber 504 by using a plurality of the seventh optical fibers 507 via the optical fiber branching switching apparatus 500.

The first optical fiber 501 includes a first plurality of cores. The first plurality of cores of the first optical fiber 501 are performed fan-in/fan-out and separated into a plurality of the fifth optical fibers 505 and a plurality of the sixth optical fibers 506 in the optical fiber branching switching apparatus 500.

The second optical fiber 502 includes a second plurality of cores. The second plurality of cores of the second optical fiber 502 are performed fan-in/fan-out and separated into a plurality of the fifth optical fibers 505 and a plurality of the seventh optical fibers 507 in the optical fiber branching switching apparatus 500.

The third optical fiber 503 includes a third plurality of cores. The third plurality of cores of the third optical fiber 503 are performed fan-in/fan-out and separated into a plurality of the sixth optical fibers 506 in the optical fiber branching switching apparatus 500.

The fourth optical fiber 504 includes a fourth plurality of cores. The fourth plurality of cores of the fourth optical fiber 504 are performed fan-in/fan-out and separated into a plurality of the seventh optical fibers 507 in the optical fiber branching switching apparatus 500.

By using the optical fiber branching switching apparatus 500 in this manner, it is possible to branch and switch a multi-core fiber to a multi-core fiber.

Referring to FIG. 6, an optical fiber branching switching apparatus 600 according to the second example embodiment further includes a first switching apparatus 601 and a second switching apparatus 602 in addition to a configuration of the optical fiber branching switching apparatus 500. In the optical fiber branching switching apparatus 600, a plurality of the sixth optical fibers 506 are connected to a plurality of the seventh optical fibers 507 via the first switching apparatus 601 and the second switching apparatus 602.

By using the optical fiber branching switching apparatus 600 in this manner, a multi-core fiber of the first optical fiber 501 can be connected to a multi-core fiber of the second optical fiber 502.

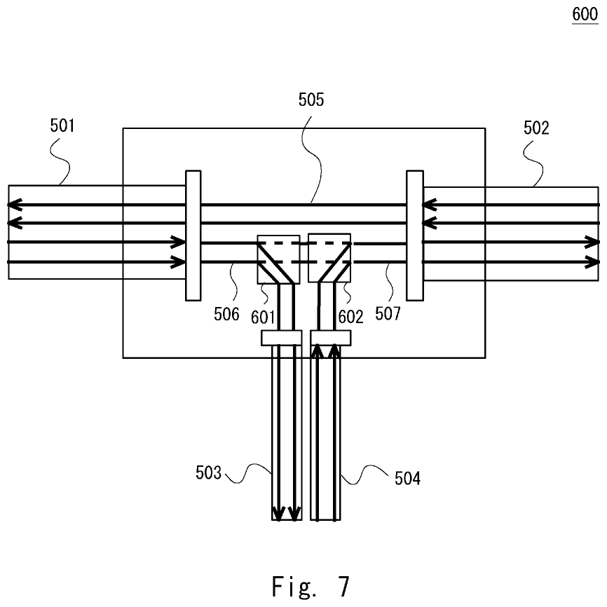

FIG. 7 illustrates, for the optical fiber branching switching apparatus 600 according to the second example embodiment, a direction from which a signal is incident and a direction to which the signal is emitted. As illustrated in FIG. 7, the fifth optical fiber 505 includes a line through which a signal is incident from the second optical fiber 502 and is emitted to the first optical fiber 501. A plurality of the fifth optical fibers 505 transmit a signal in only one direction.

The sixth optical fiber 506 includes a line through which a signal is incident from the first optical fiber 501 and is emitted to the third optical fiber 503. A plurality of the sixth optical fibers 506 transmit a signal in only one direction.

The seventh optical fiber 507 includes a line through which a signal is incident from the fourth optical fiber 504 and is emitted to the second optical fiber 502.

A plurality of the seventh optical fibers 507 transmit a signal in only one direction.

With such a configuration, the first optical fiber 501 being a multi-core fiber can transmit a transmission/reception signal. In addition, the second optical fiber 502 being a multi-core fiber can also transmit a transmission/reception signal. Further, the third optical fiber 503 and the fourth optical fiber 504 being a multi-core fiber can also transmit a transmission/reception signal.

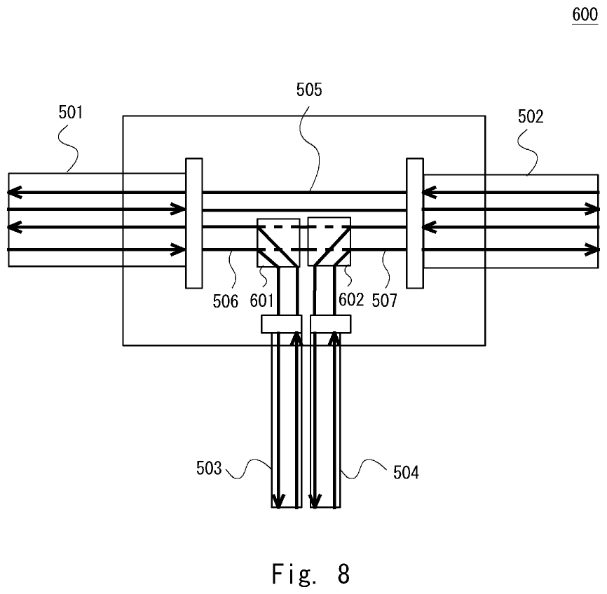

FIG. 8 illustrates, for the optical fiber branching switching apparatus 600 according to the second example embodiment, a direction from which a signal is incident and a direction to which the signal is emitted. As illustrated in FIG. 8, a plurality of the fifth optical fibers 505 include a line through which a signal is incident from the first optical fiber 501 and is emitted to the second optical fiber 502, and a line through which a signal is incident from the second optical fiber 502 and is emitted to the first optical fiber 501. A plurality of the fifth optical fibers 505 transmit a signal in bidirectional. A plurality of the sixth optical fibers 506 include a line through which a signal is incident from the first optical fiber 501 and is emitted to the third optical fiber 503, and a line through which a signal is incident from the third optical fiber 503 and is emitted to the first optical fiber 501. A plurality of the sixth optical fibers 506 transmit a signal in bidirectional. A plurality of the seventh optical fibers 507 include a line through which a signal is incident from the second optical fiber 502 and is emitted to the fourth optical fiber 504, and a line through which a signal is incident from the fourth optical fiber 504 and is emitted to the second optical fiber 502. A plurality of the seventh optical fibers 507 transmit a signal in bidirectional.

Then, the line of the sixth optical fiber 506 through which a signal is incident from the first optical fiber 501 and is emitted to the third optical fiber 503 is connected to the line of the seventh optical fiber 507 through which a signal is incident from the fourth optical fiber 504 and is emitted to the second optical fiber 502. The connection is made via the first switching apparatus 601 and the second switching apparatus 602. The line of the sixth optical fiber 506 through which a signal is incident from the third optical fiber 503 and is emitted to the first optical fiber 501 is connected to the line of the seventh optical fiber 507 through which a signal is incident from the second optical fiber 502 and is emitted to the fourth optical fiber 504. The connection is made via the first switching apparatus 601 and the second switching apparatus 602.

With such a configuration, the first optical fiber 501 being a multi-core fiber can transmit a transmission/reception signal. In addition, the second optical fiber 502 being a multi-core fiber can also transmit a transmission/reception signal. Further, the third optical fiber 503 being a multi-core fiber can also transmit a transmission/reception signal. Furthermore, the fourth optical fiber 504 being a multi-core fiber can also transmit a transmission/reception signal.

### (Description of Optical Fiber Branching Switching Apparatus According to Third Example Embodiment)

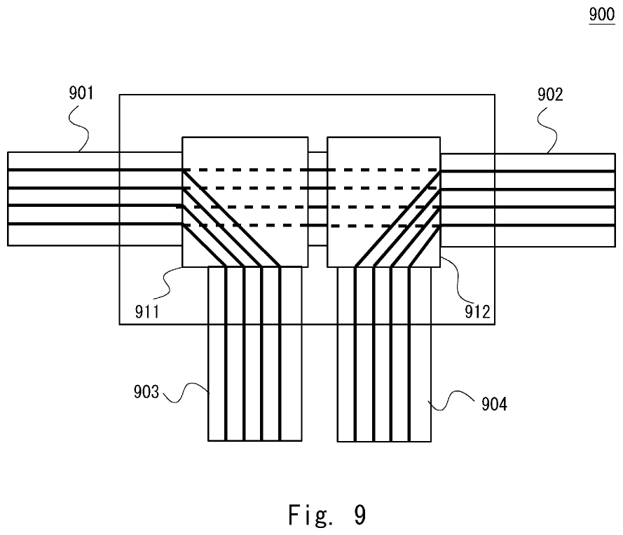

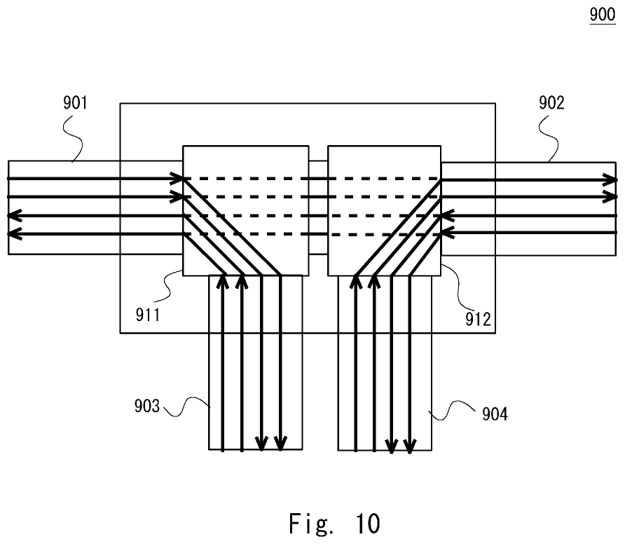

FIGS. 9 and 10 are schematic diagrams of an optical fiber branching switching apparatus according to a third example embodiment. Referring to FIGS. 9 and 10, an optical fiber branching switching apparatus according to the third example embodiment will be described.

Referring to FIG. 9, an optical fiber branching switching apparatus 900 according to the third example embodiment includes a first optical fiber 901, a second optical fiber 902, a third optical fiber 903, a fourth optical fiber 904, a first switching apparatus 911, and a second switching apparatus 912.

The first optical fiber 901 is connected to the third optical fiber 903 via the optical fiber branching switching apparatus 900. The second optical fiber 902 is connected to the fourth optical fiber 904 via the optical fiber branching switching apparatus 900.

The first optical fiber 901 includes a first plurality of cores. The second optical fiber 902 includes a second plurality of cores. The third optical fiber 903 includes a third plurality of cores. The fourth optical fiber 904 includes a fourth plurality of cores. The first plurality of cores is connected to the third plurality of cores. The second plurality of cores is connected to the fourth plurality of cores. In addition, the number of the first plurality of cores is equal to the number of the second plurality of cores. Preferably, the number of the first plurality of cores is four or more.

In the optical fiber branching switching apparatus 900, the first optical fiber 901 is connected to the second optical fiber 902 via the first switching apparatus 911 and the second switching apparatus 912.

By using the optical fiber branching switching apparatus 900 in this manner, a multi-core fiber of the first optical fiber 901 can be connected to a multi-core fiber of the second optical fiber 902.

FIG. 10 illustrates, for the optical fiber branching switching apparatus 900 according to the third example embodiment, a direction from which a signal is incident and a direction to which the signal is emitted. As illustrated in FIG. 10, the first plurality of cores of the first optical fiber 901 include a line to which a signal is incident and a line from which the signal is emitted, with respect to the optical fiber branching switching apparatus 900. The second plurality of cores of the second optical fiber 902 include a line to which a signal is incident and a line from which the signal is emitted, with respect to the optical fiber branching switching apparatus 900. The third plurality of cores of the third optical fiber 903 include a line from which a signal is incident and a line from which the signal is emitted, with respect to the optical fiber branching switching apparatus 900.

The fourth plurality of cores of the fourth optical fiber 904 include a line from which a signal is incident and a line from which the signal is emitted, with respect to the optical fiber branching switching apparatus 900.

Then, the line of the first plurality of cores through which a signal is incident to the optical fiber branching switching apparatus 900 is connected to the line of the second plurality of cores through which a signal is emitted from the optical fiber branching switching apparatus 900. In addition, the line of the first plurality of cores through which a signal is emitted from the optical fiber branching switching apparatus 900 is connected to the line of the second plurality of cores through which a signal is incident to the optical fiber branching switching apparatus 900. The connection is made via the first switching apparatus 911 and the second switching apparatus 912.

With such a configuration, the first optical fiber 901 being a multi-core fiber can transmit a transmission/reception signal. In addition, the second optical fiber 902 being a multi-core fiber can also transmit a transmission/reception signal. Further, the third optical fiber 903 being a multi-core fiber can also transmit a transmission/reception signal. Furthermore, the fourth optical fiber 904 being a multi-core fiber can also transmit a transmission/reception signal.

### (Description of Optical Fiber Branching Switching Apparatus According to Fourth Example Embodiment)

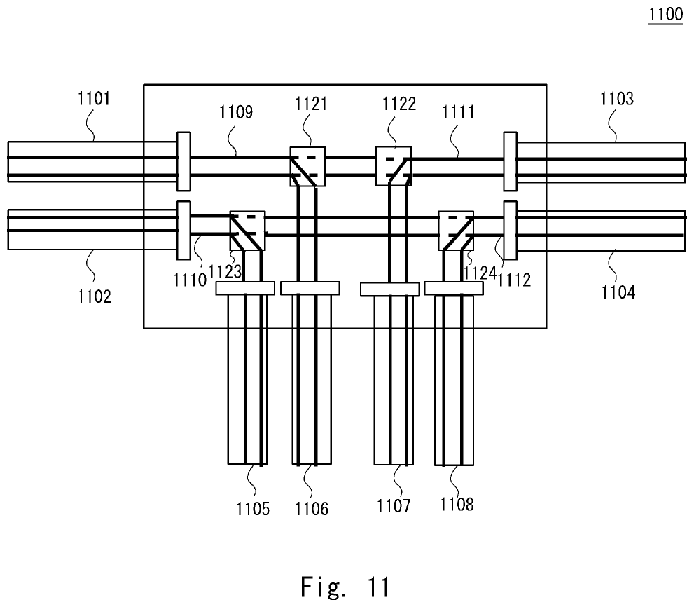

FIGS. 11 to 13 are schematic diagrams of an optical fiber branching switching apparatus according to a fourth example embodiment. Referring to FIGS. 11 to 13, an optical fiber branching switching apparatus according to the fourth example embodiment will be described.

Referring to FIG. 11, an optical fiber branching switching apparatus 1100 according to the fourth example embodiment includes a first optical fiber 1101, a second optical fiber 1102, a third optical fiber 1103, a fourth optical fiber 1104, a fifth optical fiber 1105, a sixth optical fiber 1106, a seventh optical fiber 1107, an eighth optical fiber 1108, a plurality of ninth optical fibers 1109, a plurality of tenth optical fibers 1110, a plurality of eleventh optical fibers 1111, a plurality of twelfth optical fibers 1112, a first switching apparatus 1121, a second switching apparatus 1122, a third switching apparatus 1123, and a fourth switching apparatus 1124.

The first optical fiber 1101 is connected to the sixth optical fiber 1106 by using a plurality of the ninth optical fibers 1109 via the optical fiber branching switching apparatus 1100. The second optical fiber 1102 is connected to the fifth optical fiber 1105 by using a plurality of the tenth optical fibers 1110 via the optical fiber branching switching apparatus 1100. The third optical fiber 1103 is connected to the seventh optical fiber 1107 by using a plurality of the eleventh optical fibers 1111 via the optical fiber branching switching apparatus 1100. The fourth optical fiber 1104 is connected to the eighth optical fiber 1108 by using a plurality of the twelfth optical fibers 1112 via the optical fiber branching switching apparatus 1100.

The first optical fiber 1101 includes a first plurality of cores. The first plurality of cores of the first optical fiber 1101 are performed fan-in/fan-out and separated into a plurality of the ninth optical fibers 1109 in the optical fiber branching switching apparatus 1100.

The second optical fiber 1102 includes a second plurality of cores. The second plurality of cores of the second optical fiber 1102 are performed fan-in/fan-out and separated into a plurality of the tenth optical fibers 1110 in the optical fiber branching switching apparatus 1100.

The third optical fiber 1103 includes a third plurality of cores. The third plurality of cores of the third optical fiber 1103 are performed fan-in/fan-out and separated into a plurality of the eleventh optical fibers 1111 in the optical fiber branching switching apparatus 1100.

The fourth optical fiber 1104 includes a fourth plurality of cores. The fourth plurality of cores of the fourth optical fiber 1104 are performed fan-in/fan-out and separated into a plurality of the twelfth optical fibers 1112 in the optical fiber branching switching apparatus 1100.

The fifth optical fiber 1105 includes a fifth plurality of cores. The fifth plurality of cores of the fifth optical fiber 1105 are performed fan-in/fan-out and separated into a plurality of the tenth optical fibers 1110 in the optical fiber branching switching apparatus 1100.

The sixth optical fiber 1106 includes a sixth plurality of cores. The sixth plurality of cores of the sixth optical fiber 1106 are performed fan-in/fan-out and separated into a plurality of the ninth optical fibers 1109 in the optical fiber branching switching apparatus 1100.

The seventh optical fiber 1107 includes a seventh plurality of cores. The seventh plurality of cores of the seventh optical fiber 1107 are performed fan-in/fan-out and separated into a plurality of the eleventh optical fibers 1111 in the optical fiber branching switching apparatus 1100.

The eighth optical fiber 1108 includes an eighth plurality of cores. The eighth plurality of cores of the eighth optical fiber 1108 are performed fan-in/fan-out and separated into a plurality of the twelfth optical fibers 1112 in the optical fiber branching switching apparatus 1100.

In the optical fiber branching switching apparatus 1100, a plurality of the ninth optical fibers 1109 are connected to a plurality of the eleventh optical fibers 1111 via the first switching apparatus 1121 and the second switching apparatus 1122. Therefore, it is preferable that the number of cores of the first optical fiber 1101 is equal to the number of cores of the third optical fiber 1103. In the optical fiber branching switching apparatus 1100, a plurality of the tenth optical fibers 1110 are connected to a plurality of the twelfth optical fibers 1112 via the third switching apparatus 1123 and the fourth switching apparatus 1124. Therefore, it is preferable that the number of cores of the second optical fiber 1102 is equal to the number of cores of the fourth optical fiber 1104.

By using the optical fiber branching switching apparatus 1100 in this manner, a multi-core fiber of the first optical fiber 1101 can be connected to a multi-core fiber of the third optical fiber 1103. In addition, a multi-core fiber of the second optical fiber 1102 can be connected to a multi-core fiber of the fourth optical fiber 1104.

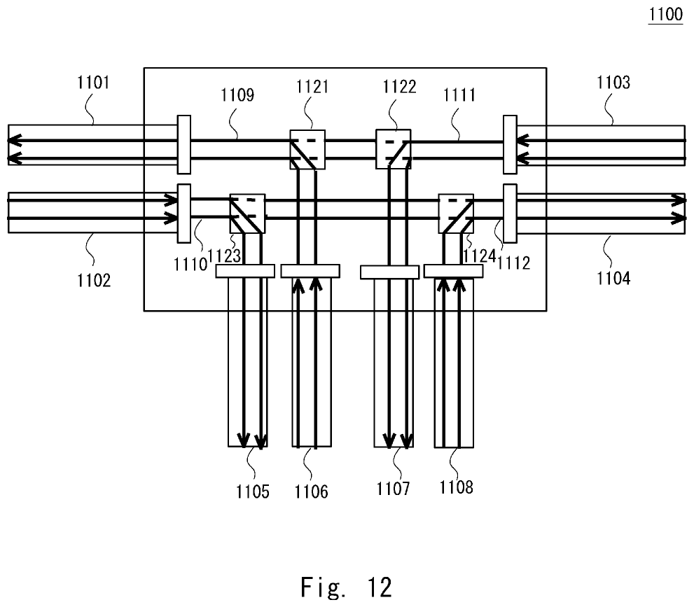

FIG. 12 illustrates, for the optical fiber branching switching apparatus 1100 according to the fourth example embodiment, a direction from which a signal is incident and a direction to which the signal is emitted. As illustrated in FIG. 12, the ninth optical fiber 1109 includes a line through which a signal is incident from the sixth optical fiber 1106 and is emitted to the first optical fiber 1101. A plurality of the ninth optical fibers 1109 transmit a signal in only one direction. The tenth optical fiber 1110 includes a line through which a signal is incident from the second optical fiber 1102 and is emitted to the fifth optical fiber 1105.

A plurality of the tenth optical fibers 1110 transmit a signal in only one direction. The eleventh optical fiber 1111 includes a line through which a signal is incident from the third optical fiber 1103 and emitted to the seventh optical fiber 1107. A plurality of the eleventh optical fibers 1111 transmit a signal in only one direction. The twelfth optical fiber 1112 includes a line through which a signal is incident from the eighth optical fiber 1108 and emitted to the fourth optical fiber 1104. A plurality of the twelfth optical fibers 1112 transmit a signal in only one direction.

With such a configuration, a signal can be transmitted from the third optical fiber 1103 to the first optical fiber 1101. In addition, a signal can be transmitted from the second optical fiber 1102 to the fourth optical fiber 1104.

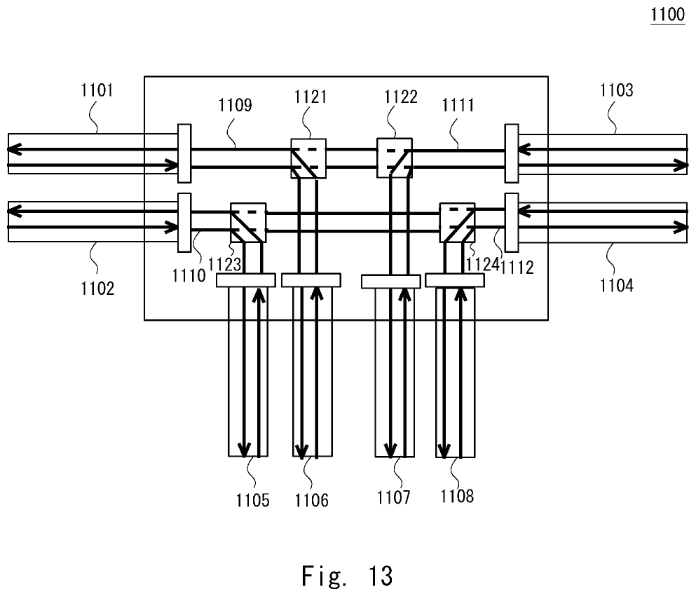

FIG. 13 illustrates, for the optical fiber branching switching apparatus 1100 according to the fourth example embodiment, a direction from which a signal is incident and a direction to which the signal is emitted. As illustrated in FIG. 13, a plurality of the ninth optical fibers 1109 include a line through which a signal is incident from the first optical fiber 1101 and is emitted to the sixth optical fiber 1106, and a line through which a signal is incident from the sixth optical fiber 1106 and emitted to the first optical fiber 1101. A plurality of the ninth optical fibers 1109 transmit a signal in bidirectional. A plurality of the tenth optical fibers 1110 include a line through which a signal is incident from the second optical fiber 1102 and is emitted to the fifth optical fiber 1105, and a line through which a signal is incident from the fifth optical fiber 1105 and is emitted to the second optical fiber 1102. A plurality of the tenth optical fibers 1110 transmit a signal in bidirectional. A plurality of the eleventh optical fibers 1111 include a line through which a signal is incident from the third optical fiber 1103 and is emitted to the seventh optical fiber 1107, and a line through which a signal is incident from the seventh optical fiber 1107 and is emitted to the third optical fiber 1103. A plurality of the eleventh optical fibers 1111 transmit a signal in bidirectional. A plurality of the twelfth optical fibers 1112 include a line through which a signal is incident from the fourth optical fiber 1104 and is emitted to the eighth optical fiber 1108, and a line through which a signal is incident from the eighth optical fiber 1108 and is emitted to the fourth optical fiber 1104. A plurality of the twelfth optical fibers 1112 transmit a signal in bidirectional.

Then, the line of the ninth optical fiber 1109 through which a signal is incident from the first optical fiber 1101 and is emitted to the sixth optical fiber 1106 is connected to the line of the eleventh optical fiber 1111 through which a signal is incident from the seventh optical fiber 1107 and is emitted to the third optical fiber 1103. The connection is made via the first switching apparatus 1121 and the second switching apparatus 1122. The line of the ninth optical fiber 1109 through which a signal is incident from the sixth optical fiber 1106 and is emitted to the first optical fiber 1101 is connected to the line of the eleventh optical fiber 1111 through which a signal is incident from the third optical fiber 1103 and is emitted to the seventh optical fiber 1107. The connection is made via the first switching apparatus 1121 and the second switching apparatus 1122.

With such a configuration, the first optical fiber 1101 being a multi-core fiber can transmit a transmission/reception signal. In addition, the third optical fiber 1103 being a multi-core fiber can also transmit a transmission/reception signal. Further, the sixth optical fiber 1106 being a multi-core fiber can also transmit a transmission/reception signal. Furthermore, the seventh optical fiber 1107 being a multi-core fiber can also transmit a transmission/reception signal.

Then, the line of the tenth optical fiber 1110 through which a signal is incident from the second optical fiber 1102 and is emitted to the fifth optical fiber 1105 is connected to the line of the twelfth optical fiber 1112 through which a signal is incident from the eighth optical fiber 1108 and is emitted to the fourth optical fiber 1104. The connection is made via the third switching apparatus 1123 and the fourth switching apparatus 1124. The line of the tenth optical fiber 1110 through which a signal is incident from the fifth optical fiber 1105 and is emitted to the second optical fiber 1102 is connected to the line of the twelfth optical fiber 1112 through which a signal is incident from the fourth optical fiber 1104 and is emitted to the eighth optical fiber 1108. The connection is made via the third switching apparatus 1123 and the fourth switching apparatus 1124.

With such a configuration, the second optical fiber 1102 being a multi-core fiber can transmit a transmission/reception signal. In addition, the fourth optical fiber 1104 being a multi-core fiber can also transmit a transmission/reception signal. Further, the fifth optical fiber 1105 being a multi-core fiber can also transmit a transmission/reception signal. Furthermore, the eighth optical fiber 1108 being a multi-core fiber can also transmit a transmission/reception signal.

### (Description of Optical Fiber Branching Switching Apparatus According to Fifth Example Embodiment)

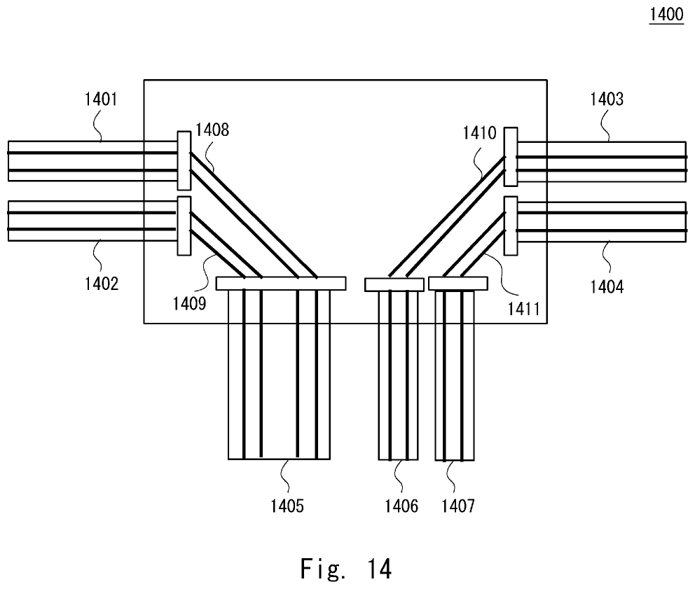

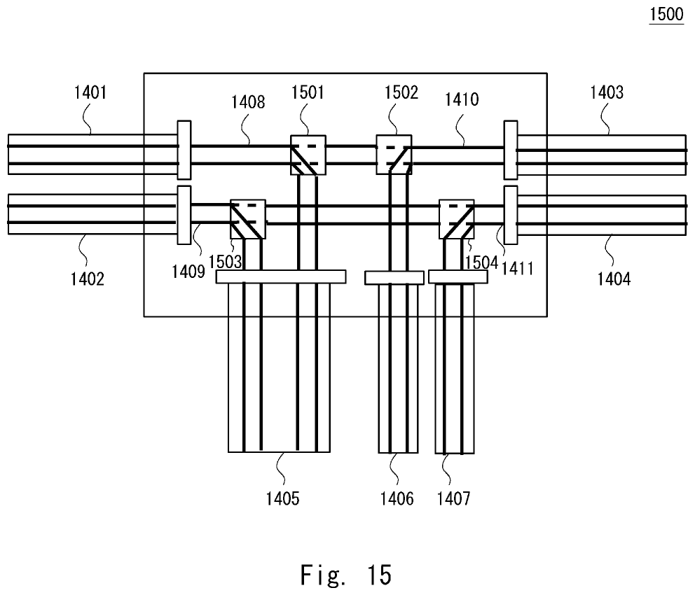

FIG. 14 is a schematic diagram of an optical fiber branching switching apparatus according to a fifth example embodiment. FIGS. 15 to 17 are schematic diagrams of another optical fiber branching switching apparatus according to the fifth example embodiment. Referring to FIGS. 14 to 17, an optical fiber branching switching apparatus according to the fifth example embodiment will be described. Referring to FIG. 14, an optical fiber branching switching apparatus 1400 according to the fifth example embodiment includes a first optical fiber 1401, a second optical fiber 1402, a third optical fiber 1403, a fourth optical fiber 1404, a fifth optical fiber 1405, a sixth optical fiber 1406, a seventh optical fiber 1407, a plurality of eighth optical fibers 1408, a plurality of ninth optical fibers 1409, a plurality of tenth optical fibers 1410, and a plurality of eleventh optical fibers 1411.

The first optical fiber 1401 is connected to the fifth optical fiber 1405 by using a plurality of the eighth optical fibers 1408 via the optical fiber branching switching apparatus 1400. The second optical fiber 1402 is connected to the fifth optical fiber 1405 by using a plurality of the ninth optical fibers 1409 via the optical fiber branching switching apparatus 1400. The third optical fiber 1403 is connected to the sixth optical fiber 1406 by using a plurality of the tenth optical fibers 1410 via the optical fiber branching switching apparatus 1400. The fourth optical fiber 1404 is connected to the seventh optical fiber 1407 by using a plurality of the eleventh optical fibers 1411 via the optical fiber branching switching apparatus 1400.

The first optical fiber 1401 includes a first plurality of cores. The first plurality of cores of the first optical fiber 1401 are performed fan-in/fan-out and separated into a plurality of the eighth optical fibers 1408 in the optical fiber branching switching apparatus 1400.

The second optical fiber 1402 includes a second plurality of cores. The second plurality of cores of the second optical fiber 1402 are performed fan-in/fan-out and separated into a plurality of the ninth optical fibers 1409 in the optical fiber branching switching apparatus 1400.

The third optical fiber 1403 includes a third plurality of cores. The third plurality of cores of the third optical fiber 1403 are performed fan-in/fan-out and separated into a plurality of the tenth optical fibers 1410 in the optical fiber branching switching apparatus 1400.

The fourth optical fiber 1404 includes a fourth plurality of cores. The fourth plurality of cores of the fourth optical fiber 1404 are performed fan-in/fan-out and separated into a plurality of the eleventh optical fibers 1411 in the optical fiber branching switching apparatus 1400.

The fifth optical fiber 1405 includes a fifth plurality of cores. The fifth plurality of cores of the fifth optical fiber 1405 are performed fan-in/fan-out and separated into a plurality of the eighth optical fibers 1408 and a plurality of the ninth optical fibers 1409 in the optical fiber branching switching apparatus 1400.

The sixth optical fiber 1406 includes a sixth plurality of cores. The sixth plurality of cores of the sixth optical fiber 1406 are performed fan-in/fan-out and separated into a plurality of the tenth optical fibers 1410 in the optical fiber branching switching apparatus 1400.

The seventh optical fiber 1407 includes a seventh plurality of cores. The seventh plurality of cores of the seventh optical fiber 1407 are performed fan-in/fan-out and separated into a plurality of the eleventh optical fibers 1411 in the optical fiber branching switching apparatus 1400.

By using the optical fiber branching switching apparatus 1400 in this manner, it is possible to branch and switch a multi-core fiber to a multi-core fiber.

Referring to FIG. 15, an optical fiber branching switching apparatus 1500 according to the fifth example embodiment further includes a first switching apparatus 1501, a second switching apparatus 1502, a third switching apparatus 1503, and a fourth switching apparatus 1504 in addition to a configuration of the optical fiber branching switching apparatus 1400. In the optical fiber branching switching apparatus 1500, a plurality of the eighth optical fibers 1408 are connected to a plurality of the tenth optical fibers 1410 via the first switching apparatus 1501 and the second switching apparatus 1502. A plurality of the ninth optical fibers 1409 are connected to a plurality of the eleventh optical fibers 1411 via the third switching apparatus 1503 and the fourth switching apparatus 1504.

By using the optical fiber branching switching apparatus 1500 in this manner, a multi-core fiber of the first optical fiber 1401 can be connected to a multi-core fiber of the third optical fiber 1403. In addition, a multi-core fiber of the second optical fiber 1402 can be connected to a multi-core fiber of the fourth optical fiber 1404.

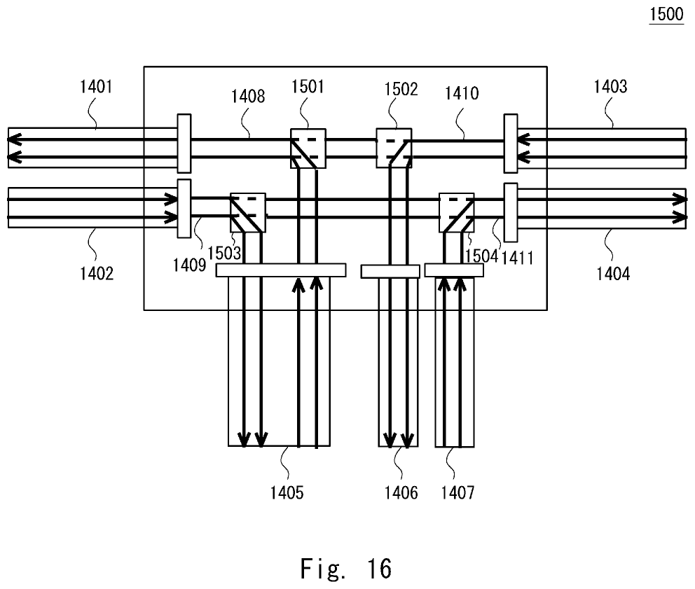

FIG. 16 illustrates, for the optical fiber branching switching apparatus 1500 according to the fifth example embodiment, a direction from which a signal is incident and a direction to which the signal is emitted. As illustrated in FIG. 16, the eighth optical fiber 1408 includes a line through which a signal is incident from the fifth optical fiber 1405 and is emitted to the first optical fiber 1401. A plurality of the eighth optical fibers 1408 transmit a signal in only one direction. The ninth optical fiber 1409 includes a line through which a signal is incident from the second optical fiber 1402 and is emitted to the fifth optical fiber 1405.

A plurality of the ninth optical fibers 1409 transmit a signal in only one direction. The tenth optical fiber 1410 includes a line through which a signal is incident from the third optical fiber 1403 and is emitted to the sixth optical fiber 1406. A plurality of the tenth optical fibers 1410 transmit a signal in only one direction.

The eleventh optical fiber 1411 includes a line through which a signal is incident from the seventh optical fiber 1407 and is emitted to the fourth optical fiber 1404. A plurality of the eleventh optical fibers 1411 transmit a signal in only one direction.

With such a configuration, a signal can be transmitted from the third optical fiber 1403 to the first optical fiber 1401. In addition, a signal can be transmitted from the second optical fiber 1402 to the fourth optical fiber 1404. In addition, the fifth optical fiber 1405 can transmit and receive a signal.

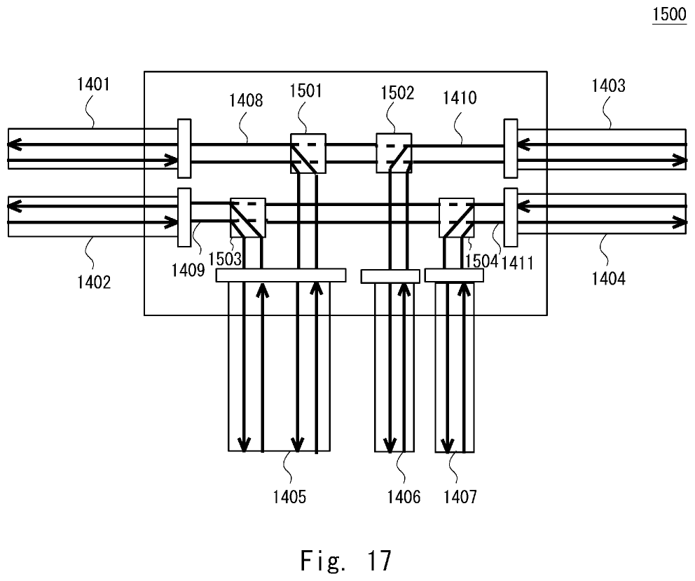

FIG. 17 illustrates, for the optical fiber branching switching apparatus 1500 according to the fifth example embodiment, a direction from which a signal is incident and a direction to which the signal is emitted. As illustrated in FIG. 17, a plurality of the eighth optical fibers 1408 include a line through which a signal is incident from the first optical fiber 1401 and is emitted to the fifth optical fiber 1405, and a line through which a signal is incident from the fifth optical fiber 1405 and is emitted the first optical fiber 1401. A plurality of the eighth optical fibers 1408 transmit a signal in bidirectional. A plurality of the ninth optical fibers 1409 include a line through which a signal is incident from the second optical fiber 1402 and is emitted to the fifth optical fiber 1405, and a line through which a signal is incident from the fifth optical fiber 1405 and is emitted the second optical fiber 1402. A plurality of the ninth optical fibers 1409 transmit a signal in bidirectional. A plurality of the tenth optical fibers 1410 include a line through which a signal is incident from the third optical fiber 1403 and is emitted to the sixth optical fiber 1406, and a line through which a signal is incident from the sixth optical fiber 1406 and is emitted to the third optical fiber 1403. A plurality of the tenth optical fibers 1410 transmit a signal in bidirectional. A plurality of the eleventh optical fibers 1411 include a line through which a signal is incident from the fourth optical fiber 1404 and is emitted to the seventh optical fiber 1407, and a line through which a signal is incident from the seventh optical fiber 1407 and is emitted to the fourth optical fiber 1404. A plurality of the eleventh optical fibers 1411 transmit a signal in bidirectional.

Then, the line of the eighth optical fiber 1408 through which a signal is incident from the first optical fiber 1401 and is emitted to the fifth optical fiber 1405 is connected to the line of the tenth optical fiber 1410 through which a signal is incident from the sixth optical fiber 1406 and is emitted to the third optical fiber 1403. The connection is made via the first switching apparatus 1501 and the second switching apparatus 1502. The line of the eighth optical fiber 1408 through which a signal is incident from the fifth optical fiber 1405 and is emitted to the first optical fiber 1401 is connected to the line of the tenth optical fiber 1410 through which a signal is incident from the third optical fiber 1403 and is emitted to the sixth optical fiber 1406. The connection is made via the first switching apparatus 1501 and the second switching apparatus 1502.

With such a configuration, the first optical fiber 1401 being a multi-core fiber can transmit a transmission/reception signal. In addition, the third optical fiber 1403 being a multi-core fiber can also transmit a transmission/reception signal. Further, the fifth optical fiber 1405 being a multi-core fiber can also transmit a transmission/reception signal. Furthermore, the sixth optical fiber 1406 being a multi-core fiber can also transmit a transmission/reception signal.

Then, the line of the ninth optical fiber 1409 through which a signal is incident from the second optical fiber 1402 and is emitted to the fifth optical fiber 1405 is connected to the line of the eleventh optical fiber 1411 through which a signal is incident from the seventh optical fiber 1407 and is emitted to the fourth optical fiber 1404. The connection is made via the third switching apparatus 1503 and the fourth switching apparatus 1504. The line of the ninth optical fiber 1409 through which a signal is incident from the fifth optical fiber 1405 and is emitted to the second optical fiber 1402 is connected to the line of the eleventh optical fiber 1411 through which a signal is incident from the fourth optical fiber 1404 and is emitted to the seventh optical fiber 1407. The connection is made via the third switching apparatus 1503 and the fourth switching apparatus 1504.

With such a configuration, the second optical fiber 1402 being a multi-core fiber can transmit a transmission/reception signal. In addition, the fourth optical fiber 1404 being a multi-core fiber can also transmit a transmission/reception signal. Further, the fifth optical fiber 1405 being a multi-core fiber can also transmit a transmission/reception signal. Furthermore, the seventh optical fiber 1407 being a multi-core fiber can also transmit a transmission/reception signal.

### (Description of Optical Fiber Branching Switching Apparatus According to Sixth Example Embodiment)

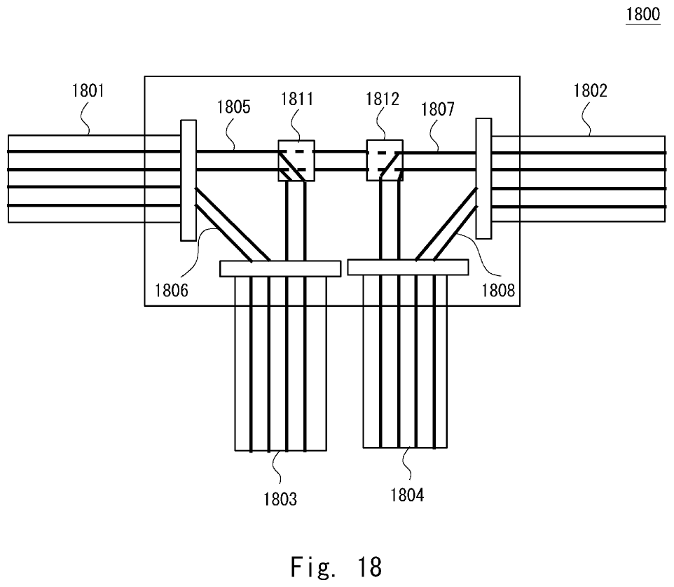

FIGS. 18 to 20 are schematic diagrams of an optical fiber branching switching apparatus according to a sixth example embodiment. Referring to FIGS. 18 to 20, an optical fiber branching switching apparatus according to the sixth example embodiment will be described.

Referring to FIG. 18, an optical fiber branching switching apparatus 1800 according to the sixth example embodiment includes a first optical fiber 1801, a second optical fiber 1802, a third optical fiber 1803, a fourth optical fiber 1804, a plurality of fifth optical fibers 1805, a plurality of sixth optical fibers 1806, a plurality of seventh optical fibers 1807, a plurality of eighth optical fibers 1808, a first switching apparatus 1811, and a second switching apparatus 1812.

The first optical fiber 1801 is connected to the third optical fiber 1803 via the optical fiber branching switching apparatus 1800 by using a plurality of the fifth optical fibers 1805 and a plurality of the sixth optical fibers 1806. The second optical fiber 1802 is connected to the fourth optical fiber 1804 via the optical fiber branching switching apparatus 1800 by using a plurality of the seventh optical fibers 1807 and a plurality of the eighth optical fibers 1808.

The first optical fiber 1801 includes a first plurality of cores. The first plurality of cores of the first optical fiber 1801 are performed fan-in/fan-out and separated into a plurality of the fifth optical fibers 1805 and a plurality of the sixth optical fibers 1806 in the optical fiber branching switching apparatus 1800.

The second optical fiber 1802 includes a second plurality of cores. The second plurality of cores of the second optical fiber 1802 are performed fan-in/fan-out and separated into a plurality of the seventh optical fibers 1807 and a plurality of the eighth optical fibers 1808 in the optical fiber branching switching apparatus 1800.

The third optical fiber 1803 includes a third plurality of cores. The third plurality of cores of the third optical fiber 1803 are performed fan-in/fan-out and separated into a plurality of the fifth optical fibers 1805 and a plurality of the sixth optical fibers 1806 in the optical fiber branching switching apparatus 1800.

The fourth optical fiber 1804 includes a fourth plurality of cores. The fourth plurality of cores of the fourth optical fiber 1804 are performed fan-in/fan-out and separated into a plurality of the seventh optical fibers 1807 and a plurality of the eighth optical fibers 1808 in the optical fiber branching switching apparatus 1800. In the optical fiber branching switching apparatus 1800, a plurality of the fifth optical fibers 1805 are connected to a plurality of the seventh optical fibers 1807 via the first switching apparatus 1811 and the second switching apparatus 1812.

By using the optical fiber branching switching apparatus 1800 in this manner, a multi-core fiber of the first optical fiber 1801 can be connected to a multi-core fiber of the second optical fiber 1802.

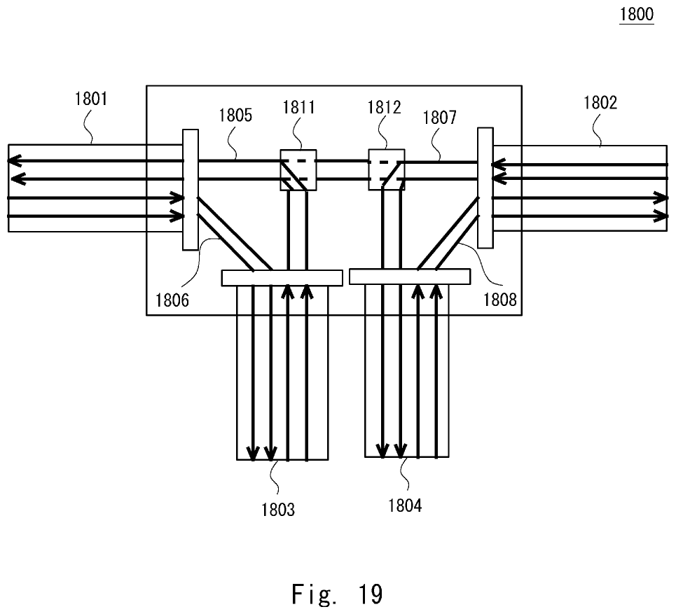

FIG. 19 illustrates, for the optical fiber branching switching apparatus 1800 according to the sixth example embodiment, a direction from which a signal is incident and a direction to which the signal is emitted. As illustrated in FIG. 19, the fifth optical fiber 1805 includes a line through which a signal is incident from the third optical fiber 1803 and is emitted to the first optical fiber 1801. A plurality of the fifth optical fibers 1805 transmit a signal in only one direction. The sixth optical fiber 1806 includes a line through which a signal is incident from the first optical fiber 1801 and is emitted to the third optical fiber 1803. A plurality of the sixth optical fibers 1806 transmit a signal in only one direction. The seventh optical fiber 1807 includes a line through which a signal is incident from the second optical fiber 1802 and is emitted to the fourth optical fiber 1804. A plurality of the seventh optical fibers 1807 transmit a signal in only one direction. The eighth optical fiber 1808 includes a line through which a signal is incident from the fourth optical fiber 1804 and is emitted to the second optical fiber 1802. A plurality of the eighth optical fibers 1808 transmit a signal in only one direction.

With such a configuration, a signal can be transmitted from the second optical fiber 1802 to the first optical fiber 1801.

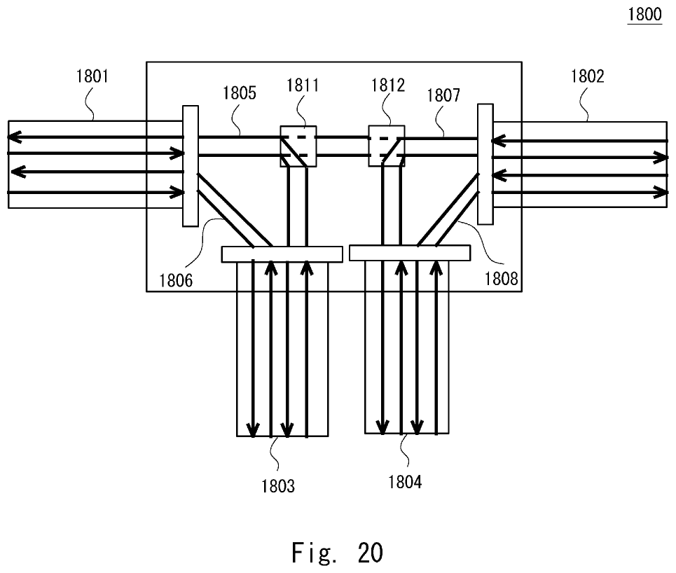

FIG. 20 illustrates, for the optical fiber branching switching apparatus 1800 according to the sixth example embodiment, a direction from which a signal is incident and a direction to which the signal is emitted. As illustrated in FIG. 20, a plurality of the fifth optical fibers 1805 include a line through which a signal is incident from the first optical fiber 1801 and is emitted to the third optical fiber 1803, and a line through which a signal is incident from the third optical fiber 1803 and is emitted to the first optical fiber 1801. A plurality of the fifth optical fibers 1805 transmit a signal in bidirectional. A plurality of the sixth optical fibers 1806 include a line through which a signal is incident from the first optical fiber 1801 and is emitted to the third optical fiber 1803, and a line through which a signal is incident from the third optical fiber 1803 and is emitted to the first optical fiber 1801. A plurality of the sixth optical fibers 1806 transmit a signal in bidirectional. A plurality of the seventh optical fibers 1807 include a line through which a signal is incident from the second optical fiber 1802 and is emitted to the fourth optical fiber 1804, and a line through which a signal is incident from the fourth optical fiber 1804 and is emitted to the second optical fiber 1802. A plurality of the seventh optical fibers 1807 transmit a signal in bidirectional. A plurality of the eighth optical fibers 1808 include a line through which a signal is incident from the second optical fiber 1802 and is emitted to the fourth optical fiber 1804, and a line through which a signal is incident from the fourth optical fiber 1804 and is emitted to the second optical fiber 1802. A plurality of the eighth optical fibers 1808 transmit a signal in bidirectional.

Then, the line of the fifth optical fiber 1805 through which a signal is incident from the first optical fiber 1801 and is emitted to the third optical fiber 1803 is connected to the line of the seventh optical fiber 1807 through which a signal is incident from the fourth optical fiber 1804 and is emitted to the second optical fiber 1802. The connection is made via the first switching apparatus 1811 and the second switching apparatus 1812. The line of the fifth optical fiber 1805 through which a signal is incident from the third optical fiber 1803 and is emitted to the first optical fiber 1801 is connected to the line of the seventh optical fiber 1807 through which a signal is incident from the second optical fiber 1802 and is emitted to the fourth optical fiber 1804. The connection is made via the first switching apparatus 1811 and the second switching apparatus 1812.

With such a configuration, the first optical fiber 1801 being a multi-core fiber can transmit a transmission/reception signal. In addition, the second optical fiber 1802 being a multi-core fiber can also transmit a transmission/reception signal. Further, the third optical fiber 1803 being a multi-core fiber can also transmit a transmission/reception signal. Furthermore, the fourth optical fiber 1804 being a multi-core fiber can also transmit a transmission/reception signal.

### (Description of Optical Fiber Branching Switching Apparatus According to Seventh Example Embodiment)

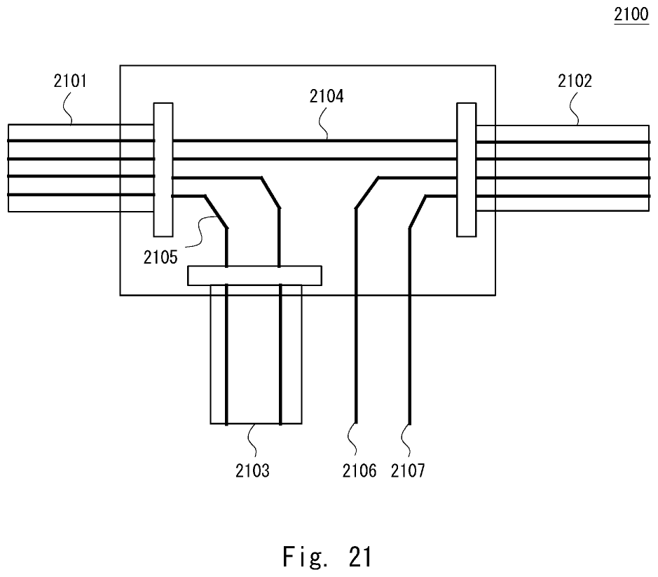

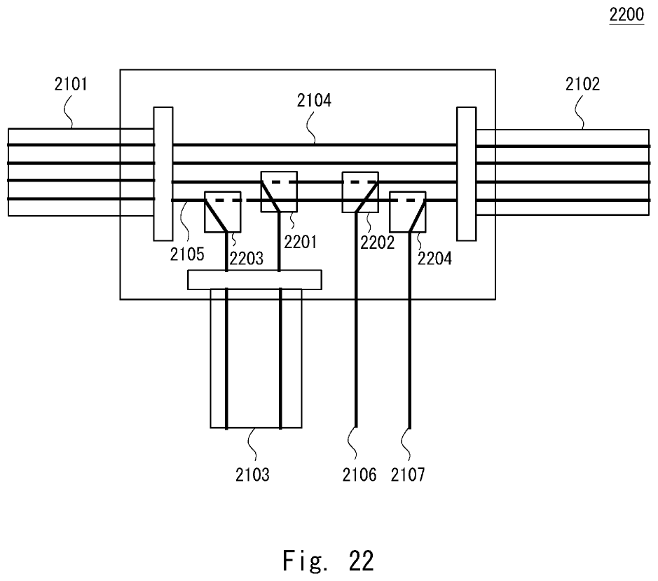

FIG. 21 is a schematic diagram of an optical fiber branching switching apparatus according to a seventh example embodiment. FIGS. 22 to 25 are schematic diagrams of another optical fiber branching switching apparatus according to the seventh example embodiment. Referring to FIGS. 21 to 25, an optical fiber branching switching apparatus according to the seventh example embodiment will be described.

Referring to FIG. 21, an optical fiber branching switching apparatus 2100 according to the seventh example embodiment includes a first optical fiber 2101, a second optical fiber 2102, a third optical fiber 2103, a plurality of fourth optical fibers 2104, a plurality of fifth optical fibers 2105, a sixth optical fiber 2106, and a seventh optical fiber 2107.

The first optical fiber 2101 is connected to the second optical fiber 2102 by using a plurality of the fourth optical fibers 2104 via the optical fiber branching switching apparatus 2100. The first optical fiber 2101 is connected to the third optical fiber 2103 by using a plurality of the fifth optical fibers 2105 via the optical fiber branching switching apparatus 2100. The second optical fiber 2102 is connected to the sixth optical fiber 2106 via the optical fiber branching switching apparatus 2100. The second optical fiber 2102 is connected to the seventh optical fiber 2107 via the optical fiber branching switching apparatus 2100.

The first optical fiber 2101 includes a first plurality of cores. The first plurality of cores of the first optical fiber 2101 are performed fan-in/fan-out and separated into a plurality of the fourth optical fibers 2104 and a plurality of the fifth optical fibers 2105 in the optical fiber branching switching apparatus 2100.

The second optical fiber 2102 includes a second plurality of cores. The second plurality of cores of the second optical fiber 2102 are performed fan-in/fan-out and separated into a plurality of the fourth optical fibers 2104, the sixth optical fiber 2106, and the seventh optical fiber 2107 in the optical fiber branching switching apparatus 2100.

The third optical fiber 103 includes a third plurality of cores. The third plurality of cores of the third optical fiber 2103 are performed fan-in/fan-out and separated into a plurality of the fifth optical fibers 2105 in the optical fiber branching switching apparatus 2100.

By using the optical fiber branching switching apparatus 2100 in this manner, it is possible to branch and switch a multi-core fiber to a multi-core fiber.

Referring to FIG. 22, an optical fiber branching switching apparatus 2200 according to the seventh example embodiment further includes a first switching apparatus 2201, a second switching apparatus 2202, a third switching apparatus 2203, and a fourth switching apparatus 2204 in addition to a configuration of the optical fiber branching switching apparatus 2100. In the optical fiber branching switching apparatus 2200, one of the fifth optical fibers 2105 is connected to the sixth optical fiber 2106 via the first switching apparatus 2201 and the second switching apparatus 2202. In addition, another one of the fifth optical fibers 2105 is connected to the seventh optical fiber 2107 via the third switching apparatus 2203 and the fourth switching apparatus 2204.

By using the optical fiber branching switching apparatus 2200 in this manner, a multi-core fiber of the first optical fiber 2101 can be connected to a multi-core fiber of the second optical fiber 2102.

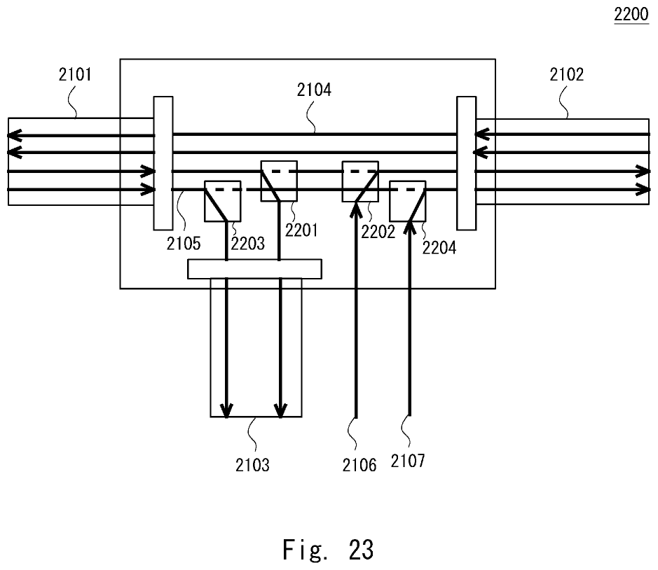

FIG. 23 illustrates, for the optical fiber branching switching apparatus 2200 according to the seventh example embodiment, a direction from which a signal is incident and a direction to which the signal is emitted. As illustrated in FIG. 23, the fourth optical fiber 2104 includes a line through which a signal is incident from the second optical fiber 2102 and is emitted to the first optical fiber 2101.

A plurality of the fourth optical fibers 2104 transmit a signal in only one direction. The fifth optical fiber 2105 includes a line through which a signal is incident from the first optical fiber 2101 and is emitted to the third optical fiber 2103. A plurality of the fifth optical fibers 2105 transmit a signal in only one direction. The sixth optical fiber 2106 includes a line through which a signal is emitted to the second optical fiber 2102. The seventh optical fiber 2107 includes a line through which a signal is emitted to the second optical fiber 2102.

With such a configuration, the first optical fiber 2101 being a multi-core fiber can transmit a transmission/reception signal. In addition, the second optical fiber 2102 being a multi-core fiber can also transmit a transmission/reception signal.

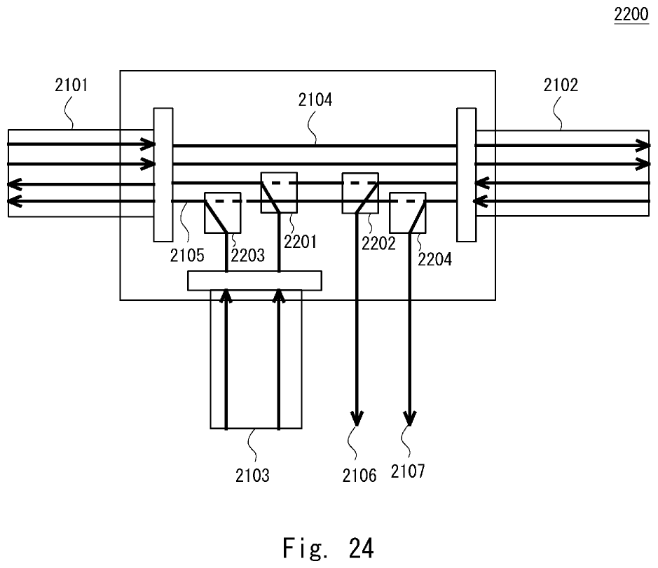

FIG. 24 illustrates, for the optical fiber branching switching apparatus 2200 according to the seventh example embodiment, a direction from which a signal is incident and a direction to which the signal is emitted. As illustrated in FIG. 24, the fourth optical fiber 2104 includes a line through which a signal is incident from the first optical fiber 2101 and is emitted to the second optical fiber 2102.

A plurality of the fourth optical fibers 2104 transmit a signal in only one direction. The fifth optical fiber 2105 includes a line through which a signal is incident from the third optical fiber 2103 and is emitted to the first optical fiber 2101. A plurality of the fifth optical fibers 2105 transmit a signal in only one direction. The sixth optical fiber 2106 includes a line through which a signal is incident from the second optical fiber 2102. The seventh optical fiber 2107 includes a line through which a signal is incident from the second optical fiber 2102.

With such a configuration, the first optical fiber 2101 being a multi-core fiber can transmit a transmission/reception signal. In addition, the second optical fiber 2102 being a multi-core fiber can also transmit a transmission/reception signal.

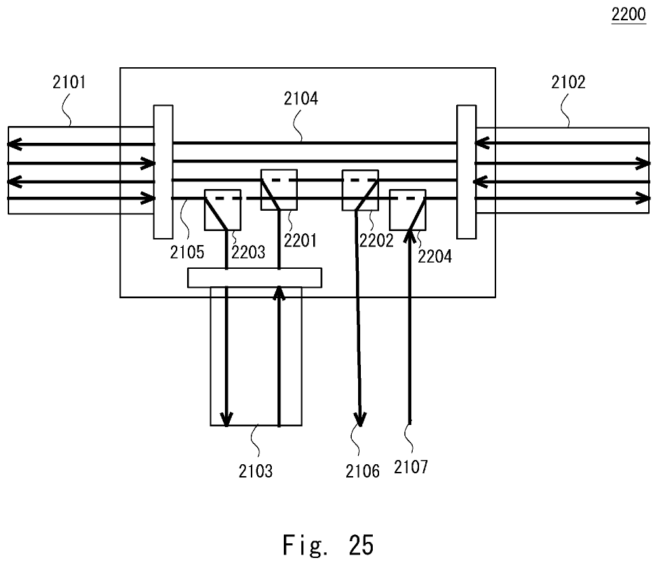

FIG. 25 illustrates, for the optical fiber branching switching apparatus 2200 according to the seventh example embodiment, a direction from which a signal is incident and a direction to which the signal is emitted. As illustrated in FIG. 25, a plurality of the fourth optical fibers 2104 include a line through which a signal is incident from the first optical fiber 2101 and is emitted to the second optical fiber 2102, and a line through which a signal is incident from the second optical fiber 2102 and is emitted to the first optical fiber 2101. A plurality of the fourth optical fibers 2104 transmit a signal in bidirectional. A plurality of the fifth optical fibers 2105 include a line through which a signal is incident from the first optical fiber 2101 and is emitted to the third optical fiber 2103, and a line through which a signal is incident from the third optical fiber 2103 and is emitted to the first optical fiber 2101. A plurality of the fifth optical fibers 2105 transmit a signal in bidirectional. The sixth optical fiber 2106 includes a line through which a signal is incident from the second optical fiber 2102. The seventh optical fiber 2107 includes a line through which a signal is emitted to the second optical fiber 2102. Then, the line of the fifth optical fiber 2105 through which a signal is incident from the first optical fiber 2101 and is emitted to the third optical fiber 2103 is connected to the seventh optical fiber 2107. The connection is made via the third switching apparatus 2203 and the fourth switching apparatus 2204. The line of the fifth optical fiber 2105 through which a signal is incident from the third optical fiber 2103 and is emitted to the first optical fiber 2101 is connected to the sixth optical fiber 2106. The connection is made via the first switching apparatus 2201 and the second switching apparatus 2202.

With such a configuration, the first optical fiber 2101 being a multi-core fiber can transmit a transmission/reception signal. In addition, the second optical fiber 2102 being a multi-core fiber can also transmit a transmission/reception signal. Further, the third optical fiber 2103 being a multi-core fiber can also transmit a transmission/reception signal.

As described above, the optical fiber branching switching apparatus according to the first to seventh example embodiments can branch a plurality of optical fibers by using a fan-in/fan-out device for a multi-core fiber. The first to seventh example embodiments can be combined as desirable by one of ordinary skill in the art. Note that, the present disclosure is not limited to the above-described example embodiments, and can be appropriately modified without departing from the scope of the present disclosure.

The whole or part of the example embodiments disclosed above can be described as, but not limited to, the following supplementary notes.

### (Supplementary Note 1)

An optical fiber branching switching apparatus including:
a first optical fiber; a second optical fiber; a third optical fiber; a plurality of fourth optical fibers; a plurality of fifth optical fibers; and a plurality of sixth optical fibers, wherein
the first optical fiber is connected to the second optical fiber by using a plurality of the fourth optical fibers,
the first optical fiber is connected to the third optical fiber by using a plurality of the fifth optical fibers, and
the second optical fiber is connected to the third optical fiber by using a plurality of the sixth optical fibers.

### (Supplementary Note 2)

The optical fiber branching switching apparatus according to supplementary note 1, wherein
the first optical fiber includes a first plurality of cores,
the second optical fiber includes a second plurality of cores,
the third optical fiber includes a third plurality of cores,
the first plurality of cores are separated into a plurality of the fourth optical fibers and a plurality of the fifth optical fibers,
the second plurality of cores are separated into a plurality of the fourth optical fibers and a plurality of the sixth optical fibers, and
the third plurality of cores are separated into a plurality of the fifth optical fibers and a plurality of the sixth optical fibers.

### (Supplementary Note 3)

The optical fiber branching switching apparatus according to supplementary note 2, wherein fan-in/fan-out is performed from the first optical fiber to a plurality of the fourth optical fibers and a plurality of the fifth optical fibers, fan-in/fan-out is performed from the second optical fiber to a plurality of the fourth optical fibers and a plurality of the sixth optical fibers, and fan-in/fan-out is performed from the third optical fiber to a plurality of the fifth optical fibers and a plurality of the sixth optical fibers.

### (Supplementary Note 4)

The optical fiber branching switching apparatus according to supplementary note 1, further including:
a first switching apparatus; and a second switching apparatus,
wherein a plurality of the fifth optical fibers are connected to a plurality of the sixth optical fibers via the first switching apparatus and the second switching apparatus.

### (Supplementary Note 5)

The optical fiber branching switching apparatus according to supplementary note 4, wherein
the fourth optical fiber includes a line being incident from the second optical fiber and emitted to the first optical fiber,
the fifth optical fiber includes a line being incident from the first optical fiber and emitted to the third optical fiber, and
the sixth optical fiber includes a line being incident from the third optical fiber and emitted to the second optical fiber.

### (Supplementary Note 6)

The optical fiber branching switching apparatus according to supplementary note 4, wherein
a plurality of the fourth optical fibers include at least a line being incident from the first optical fiber and emitted to the second optical fiber, and a line being incident from the second optical fiber and emitted to the first optical fiber,
a plurality of the fifth optical fibers include at least a line being incident from the first optical fiber and emitted to the third optical fiber, and a line being incident from the third optical fiber and emitted to the first optical fiber,
a plurality of the sixth optical fibers include at least a line being incident from the second optical fiber and emitted to the third optical fiber, and a line being incident from the third optical fiber and emitted to the second optical fiber,
a line of the fifth optical fiber being incident from the first optical fiber and emitted to the third optical fiber is connected to a line of the sixth optical fiber being incident from the third optical fiber and emitted to the second optical fiber, and
a line of the fifth optical fiber being incident from the third optical fiber and emitted to the first optical fiber is connected to a line of the sixth optical fiber being incident from the second optical fiber and emitted to the third optical fiber.

### (Supplementary Note 7)

An optical fiber branching switching apparatus including:
a first optical fiber; a second optical fiber; a third optical fiber; a fourth optical fiber; a plurality of fifth optical fibers; a plurality of sixth optical fibers; and a plurality of seventh optical fibers, wherein
the first optical fiber is connected to the second optical fiber by using a plurality of the fifth optical fibers,
the first optical fiber is connected to the third optical fiber by using a plurality of the sixth optical fibers, and
the second optical fiber is connected to the fourth optical fiber by using a plurality of the seventh optical fibers.

### (Supplementary Note 8)

The optical fiber branching switching apparatus according to supplementary note 7, wherein
the first optical fiber includes a first plurality of cores,
the second optical fiber includes a second plurality of cores,
the first plurality of cores are separated into a plurality of the fifth optical fibers and a plurality of the sixth optical fibers, and
the second plurality of cores are separated into a plurality of the fifth optical fibers and a plurality of the seventh optical fibers.

### (Supplementary Note 9)

The optical fiber branching switching apparatus according to supplementary note 7, wherein fan-in/fan-out is performed from the first optical fiber to a plurality of the fifth optical fibers and a plurality of the sixth optical fibers, fan-in/fan-out is performed from the second optical fiber to a plurality of the fifth optical fibers and a plurality of the seventh optical fibers, fan-in/fan-out is performed from the third optical fiber to a plurality of the sixth optical fibers, and fan-in/fan-out is performed from the fourth optical fiber to a plurality of the seventh optical fibers.

### (Supplementary Note 10)

The optical fiber branching switching apparatus according to supplementary note 7, further including:
a first switching apparatus; and a second switching apparatus,
wherein a plurality of the sixth optical fibers are connected to a plurality of the seventh optical fibers via the first switching apparatus and the second switching apparatus.

### (Supplementary Note 11)

The optical fiber branching switching apparatus according to supplementary note 10, wherein
the fifth optical fiber includes a line being incident from the second optical fiber and emitted to the first optical fiber,
the sixth optical fiber includes a line being incident from the first optical fiber and emitted to the third optical fiber, and
the seventh optical fiber includes a line being incident from the fourth optical fiber and emitted to the second optical fiber.

### (Supplementary Note 12)

The optical fiber branching switching apparatus according to supplementary note 10, wherein
a plurality of the fifth optical fibers include at least a line being incident from the first optical fiber and emitted to the second optical fiber, and a line being incident from the second optical fiber and emitted to the first optical fiber,
a plurality of the sixth optical fibers include at least a line being incident from the first optical fiber and emitted to the third optical fiber, and a line being incident from the third optical fiber and emitted to the first optical fiber,
a plurality of the seventh optical fibers include at least a line being incident from the second optical fiber and emitted to the fourth optical fiber, and a line being incident from the fourth optical fiber and emitted to the second optical fiber,
a line of the sixth optical fiber being incident from the first optical fiber and emitted to the third optical fiber is connected to a line of the seventh optical fiber being incident from the fourth optical fiber and emitted to the second optical fiber, and
a line of the sixth optical fiber being incident from the third optical fiber and emitted to the first optical fiber is connected to a line of the seventh optical fiber being incident from the second optical fiber and emitted to the fourth optical fiber.

### (Supplementary Note 13)

An optical fiber branching switching apparatus including:
a first optical fiber including a first plurality of cores; a second optical fiber including a second plurality of cores; a third optical fiber including a third plurality of cores; a fourth optical fiber including a fourth plurality of cores;
a first switching apparatus; and a second switching apparatus, wherein
the first plurality of cores are connected to the third plurality of cores,
the second plurality of cores are connected to the fourth plurality of cores, and
the first plurality of cores are connected to the second plurality of cores via the first switching apparatus and the second switching apparatus.

### (Supplementary Note 14)

The optical fiber branching switching apparatus according to supplementary note 13, wherein the number of the first plurality of cores is equal to the number of the second plurality of cores.

### (Supplementary Note 15)

The optical fiber branching switching apparatus according to supplementary note 14, wherein the number of the first plurality of cores is four or more.

### (Supplementary Note 16)

The optical fiber branching switching apparatus according to any one of supplementary notes 13 to 15, wherein
the first plurality of cores include at least, with respect to the optical fiber branching switching apparatus, a line being incident to and a line being emitted from,
the second plurality of cores include at least, with respect to the optical fiber branching switching apparatus, a line being incident to and a line being emitted from,
a line of the first plurality of cores being incident to the optical fiber branching switching apparatus is connected to a line of the second plurality of cores being emitted from the optical fiber branching switching apparatus, and
a line of the first plurality of cores being emitted from the optical fiber branching switching apparatus is connected to a line of the second plurality of cores being incident to the optical fiber branching switching apparatus.

### (Supplementary Note 17)

An optical fiber branching switching apparatus including:
a first optical fiber; a second optical fiber; a third optical fiber; a fourth optical fiber; a fifth optical fiber; a sixth optical fiber; a seventh optical fiber; an eighth optical fiber; a plurality of ninth optical fibers; a plurality of tenth optical fibers; a plurality of eleventh optical fibers; a plurality of twelfth optical fibers;
a first switching apparatus; a second switching apparatus; a third switching apparatus; and a fourth switching apparatus, wherein
the first optical fiber is connected to the sixth optical fiber by using a plurality of the ninth optical fibers,
the second optical fiber is connected to the fifth optical fiber by using a plurality of the tenth optical fibers,
the third optical fiber is connected to the seventh optical fiber by using a plurality of the eleventh optical fibers,
the fourth optical fiber is connected to the eighth optical fiber by using a plurality of the twelfth optical fibers,
a plurality of the ninth optical fibers are connected to a plurality of the eleventh optical fibers via the first switching apparatus and the second switching apparatus, and
a plurality of the tenth optical fibers are connected to a plurality of the twelfth optical fibers via the third switching apparatus and the fourth switching apparatus.

### (Supplementary Note 18)

The optical fiber branching switching apparatus according to supplementary note 17, wherein
the number of cores of the first optical fiber is equal to the number of cores of the third optical fiber, and
the number of cores of the second optical fiber is equal to the number of cores of the fourth optical fiber.

### (Supplementary Note 19)

The optical fiber branching switching apparatus according to supplementary note 17 or 18, wherein
the ninth optical fiber is a line being incident from the sixth optical fiber and emitted to the first optical fiber,
the tenth optical fiber is a line being incident from the second optical fiber and emitted to the fifth optical fiber,
the eleventh optical fiber is a line being incident from the third optical fiber and emitted to the seventh optical fiber, and
the twelfth optical fiber is a line being incident from the eighth optical fiber and emitted to the fourth optical fiber.

### (Supplementary Note 20)

The optical fiber branching switching apparatus according to supplementary note 17 or 18, wherein
a plurality of the ninth optical fibers include at least a line being incident from the first optical fiber and emitted to the sixth optical fiber, and a line being incident from the sixth optical fiber and emitted to the first optical fiber,
a plurality of the tenth optical fibers include at least a line being incident from the second optical fiber and emitted to the fifth optical fiber, and a line being incident from the fifth optical fiber and emitted to the second optical fiber,
a plurality of the eleventh optical fibers include at least a line being incident from the third optical fiber and emitted to the seventh optical fiber, and a line being incident from the seventh optical fiber and emitted to the third optical fiber,
a plurality of the twelfth optical fibers include at least a line being incident from the fourth optical fiber and emitted to the eighth optical fiber, and a line being incident from the eighth optical fiber and emitted to the fourth optical fiber,
a line of the ninth optical fiber being incident from the first optical fiber and emitted to the sixth optical fiber is connected to a line of the eleventh optical fiber being incident from the seventh optical fiber and emitted to the third optical fiber,
a line of the ninth optical fiber being incident from the sixth optical fiber and emitted to the first optical fiber is connected to a line of the eleventh optical fiber being incident from the third optical fiber and emitted to the seventh optical fiber,
a line of the tenth optical fiber being incident from the second optical fiber and emitted to the fifth optical fiber is connected to a line of the twelfth optical fiber being incident from the eighth optical fiber and emitted to the fourth optical fiber, and
a line of the tenth optical fiber being incident from the fifth optical fiber and emitted to the second optical fiber is connected to a line of the twelfth optical fiber being incident from the fourth optical fiber and emitted to the eighth optical fiber.

### (Supplementary Note 21)

An optical fiber branching switching apparatus including:
a first optical fiber; a second optical fiber; a third optical fiber; a fourth optical fiber; a fifth optical fiber; a sixth optical fiber; a seventh optical fiber; a plurality of eighth optical fibers; a plurality of ninth optical fibers; a plurality of tenth optical fibers; and a plurality of eleventh optical fibers, wherein
the first optical fiber is connected to the fifth optical fiber by using a plurality of the eighth optical fibers,
the second optical fiber is connected to the fifth optical fiber by using a plurality of the ninth optical fibers,
the third optical fiber is connected to the sixth optical fiber by using a plurality of the tenth optical fibers, and
the fourth optical fiber is connected to the seventh optical fiber by using a plurality of the eleventh optical fibers.

### (Supplementary Note 22)

The optical fiber branching switching apparatus according to supplementary note 21, wherein
the fifth optical fiber includes a first plurality of cores, and
the first plurality of cores are separated into a plurality of the eighth optical fibers and a plurality of the ninth optical fibers.

### (Supplementary Note 23)

The optical fiber branching switching apparatus according to supplementary note 21, wherein fan-in/fan-out is performed from the fifth optical fiber to a plurality of the eighth optical fibers and a plurality of the ninth optical fibers.

### (Supplementary Note 24)

The optical fiber branching switching apparatus according to supplementary note 21, further including:
a first switching apparatus; a second switching apparatus; a third switching apparatus; and a fourth switching apparatus, wherein
a plurality of the eighth optical fibers are connected to a plurality of the tenth optical fibers via the first switching apparatus and the second switching apparatus, and
a plurality of the ninth optical fibers are connected to a plurality of the eleventh optical fibers via the third switching apparatus and the fourth switching apparatus.

### (Supplementary Note 25)

The optical fiber branching switching apparatus according to supplementary note 24, wherein
the eighth optical fiber includes a line being incident from the fifth optical fiber and emitted to the first optical fiber,
the ninth optical fiber includes a line being incident from the second optical fiber and emitted to the fifth optical fiber,
the tenth optical fiber includes a line being incident from the third optical fiber and emitted to the sixth optical fiber, and
the eleventh optical fiber includes a line being incident from the eighth optical fiber and emitted to the fourth optical fiber.

### (Supplementary Note 26)

The optical fiber branching switching apparatus according to any one of supplementary notes 21 to 25, wherein
a plurality of the eighth optical fibers include at least a line being incident from the first optical fiber and emitted to the fifth optical fiber, and a line being incident from the fifth optical fiber and emitted to the first optical fiber,
a plurality of the ninth optical fiber include at least a line being incident from the second optical fiber and emitted to the fifth optical fiber, and a line being incident from the fifth optical fiber and emitted to the second optical fiber,
a plurality of the tenth optical fibers include at least a line being incident from the third optical fiber and emitted to the sixth optical fiber, and a line being incident from the sixth optical fiber and emitted to the third optical fiber,
a plurality of the eleventh optical fibers include at least a line being incident from the fourth optical fiber and emitted to the seventh optical fiber, and a line being incident from the seventh optical fiber and emitted to the fourth optical fiber,
a line of the eighth optical fiber being incident from the first optical fiber and emitted to the fifth optical fiber is connected to a line of the tenth optical fiber being incident from the sixth optical fiber and emitted to the third optical fiber,
a line of the eighth optical fiber being incident from the fifth optical fiber and emitted to the first optical fiber is connected to a line of the tenth optical fiber being incident from the third optical fiber and emitted to the sixth optical fiber,
a line of the ninth optical fiber being incident from the second optical fiber and emitted to the fifth optical fiber is connected to a line of the eleventh optical fiber being incident from the seventh optical fiber and emitted to the fourth optical fiber, and
a line of the ninth optical fiber being incident from the fifth optical fiber and emitted to the second optical fiber is connected to a line of the eleventh optical fiber being incident from the fourth optical fiber and emitted to the seventh optical fiber.

### (Supplementary Note 27)

An optical fiber branching switching apparatus including:
a first optical fiber; a second optical fiber; a third optical fiber; a fourth optical fiber; a plurality of fifth optical fibers; a plurality of sixth optical fibers; a plurality of seventh optical fibers; a plurality of eighth optical fibers;
a first switching apparatus; and a second switching apparatus, wherein
the first optical fiber is connected to the third optical fiber by using a plurality of the fifth optical fibers and a plurality of the sixth optical fibers,
the second optical fiber is connected to the fourth optical fiber by using a plurality of the seventh optical fibers and a plurality of the eighth optical fibers, and
a plurality of the fifth optical fibers are connected to a plurality of the seventh optical fibers via the first switching apparatus and the second switching apparatus.

### (Supplementary Note 28)

The optical fiber branching switching apparatus according to supplementary note 27, wherein
the fifth optical fiber is a line being incident from the third optical fiber and emitted to the first optical fiber, and
the seventh optical fiber is a line being incident from the second optical fiber and emitted to the fourth optical fiber.

### (Supplementary Note 29)

The optical fiber branching switching apparatus according to supplementary note 27, wherein
a plurality of the fifth optical fibers include at least a line being incident from the first optical fiber and emitted to the third optical fiber, and a line being incident from the third optical fiber and emitted to the first optical fiber,
a plurality of the seventh optical fibers include at least a line being incident from the second optical fiber and emitted to the fourth optical fiber, and a line being incident from the fourth optical fiber and emitted to the second optical fiber,
a line of the fifth optical fiber being incident from the first optical fiber and emitted to the third optical fiber is connected to a line of the seventh optical fiber being incident from the fourth optical fiber and emitted to the second optical fiber, and
a line of the fifth optical fiber being incident from the third optical fiber and emitted to the first optical fiber is connected to a line of the seventh optical fiber being incident from the second optical fiber and emitted to the fourth optical fiber.

### (Supplementary Note 30)

An optical fiber branching switching apparatus including:
a first optical fiber; a second optical fiber; a third optical fiber; a plurality of fourth optical fibers; a plurality of fifth optical fibers; a sixth optical fiber; and a seventh optical fiber, wherein
the first optical fiber is connected to the second optical fiber by using a plurality of the fourth optical fibers,
the first optical fiber is connected to the third optical fiber by using a plurality of the fifth optical fibers,
the second optical fiber is connected to the sixth optical fiber, and
the second optical fiber is connected to the seventh optical fiber.

### (Supplementary Note 31)

The optical fiber branching switching apparatus according to supplementary note 30, wherein
the first optical fiber is separated into a plurality of the fourth optical fibers and a plurality of the fifth optical fibers, and
the second optical fiber is separated into a plurality of the fourth optical fibers, the sixth optical fiber, and the seventh optical fiber.

### (Supplementary Note 32)

The optical fiber branching switching apparatus according to supplementary note 30, wherein
fan-in/fan-out is performed from the first optical fiber to a plurality of the fourth optical fibers and a plurality of the fifth optical fibers, and
fan-in/fan-out is performed from the second optical fiber to a plurality of the fourth optical fibers, the sixth optical fiber, and the seventh optical fiber.

### (Supplementary Note 33)

The optical fiber branching switching apparatus according to supplementary note 32, further including:
a first switching apparatus; a second switching apparatus; a third switching apparatus; and a fourth switching apparatus, wherein
one of a plurality of the fifth optical fibers is connected to the sixth optical fiber via the first switching apparatus and the second switching apparatus, and
another of a plurality of the fifth optical fibers is connected to the seventh optical fiber via the third switching apparatus and the fourth switching apparatus.

### (Supplementary Note 34)

The optical fiber branching switching apparatus according to supplementary note 33, wherein
the fourth optical fiber includes a line being incident from the second optical fiber and emitted to the first optical fiber,
the fifth optical fiber includes a line being incident from the first optical fiber and emitted to the third optical fiber,
the sixth optical fiber includes a line being emitted to the second optical fiber, and
the seventh optical fiber includes a line being emitted to the second optical fiber.

### (Supplementary Note 35)

The optical fiber branching switching apparatus according to supplementary note 33, wherein
the fourth optical fiber includes a line being incident from the first optical fiber and emitted to the second optical fiber,
the fifth optical fiber includes a line being incident from the third optical fiber and emitted to the first optical fiber,
the sixth optical fiber includes a line being incident from the second optical fiber, and
the seventh optical fiber includes a line being incident from the second optical fiber.

### (Supplementary Note 36)

The optical fiber branching switching apparatus according to supplementary note 33, wherein
the sixth optical fiber is a line being incident from the second optical fiber,
the seventh optical fiber is a line being emitted to the second optical fiber,
one of a plurality of the fifth optical fibers is a line being incident from the third optical fiber and emitted to the first optical fiber, and
another of a plurality of the fifth optical fibers is a line being incident from the first optical fiber and emitted to the third optical fiber.

According to the present disclosure, it is possible to provide an optical fiber branching switching apparatus that branches and switches a multi-core fiber to a multi-core fiber.
While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. An optical fiber branching switching apparatus comprising:
a first optical fiber; a second optical fiber; a third optical fiber; a plurality of fourth optical fibers; a plurality of fifth optical fibers; and a plurality of sixth optical fibers, wherein
the first optical fiber is connected to the second optical fiber by using a plurality of the fourth optical fibers,
the first optical fiber is connected to the third optical fiber by using a plurality of the fifth optical fibers, and
the second optical fiber is connected to the third optical fiber by using a plurality of the sixth optical fibers.

2. The optical fiber branching switching apparatus according to claim 1, wherein the first optical fiber includes a first plurality of cores,
the second optical fiber includes a second plurality of cores,
the third optical fiber includes a third plurality of cores,
the first plurality of cores are separated into a plurality of the fourth optical fibers and a plurality of the fifth optical fibers,
the second plurality of cores are separated into a plurality of the fourth optical fibers and a plurality of the sixth optical fibers, and
the third plurality of cores are separated into a plurality of the fifth optical fibers and a plurality of the sixth optical fibers.

3. The optical fiber branching switching apparatus according to claim 2, wherein fan-in/fan-out is performed from the first optical fiber to a plurality of the fourth optical fibers and a plurality of the fifth optical fibers, fan-in/fan-out is performed from the second optical fiber to a plurality of the fourth optical fibers and a plurality of the sixth optical fibers, and fan-in/fan-out is performed from the third optical fiber to a plurality of the fifth optical fibers and a plurality of the sixth optical fibers.

4. The optical fiber branching switching apparatus according to claim 1, further comprising:
a first switching apparatus; and a second switching apparatus,
wherein a plurality of the fifth optical fibers are connected to a plurality of the sixth optical fibers via the first switching apparatus and the second switching apparatus.

5. The optical fiber branching switching apparatus according to claim 4, wherein
the fourth optical fiber includes a line being incident from the second optical fiber and emitted to the first optical fiber,
the fifth optical fiber includes a line being incident from the first optical fiber and emitted to the third optical fiber, and
the sixth optical fiber includes a line being incident from the third optical fiber and emitted to the second optical fiber.

6. The optical fiber branching switching apparatus according to claim 4, wherein
a plurality of the fourth optical fibers include at least a line being incident from the first optical fiber and emitted to the second optical fiber, and a line being incident from the second optical fiber and emitted to the first optical fiber,
a plurality of the fifth optical fibers include at least a line being incident from the first optical fiber and emitted to the third optical fiber, and a line being incident from the third optical fiber and emitted to the first optical fiber,
a plurality of the sixth optical fibers include at least a line being incident from the second optical fiber and emitted to the third optical fiber, and a line being incident from the third optical fiber and emitted to the second optical fiber,
a line of the fifth optical fiber being incident from the first optical fiber and emitted to the third optical fiber is connected to a line of the sixth optical fiber being incident from the third optical fiber and emitted to the second optical fiber, and
a line of the fifth optical fiber being incident from the third optical fiber and emitted to the first optical fiber is connected to a line of the sixth optical fiber being incident from the second optical fiber and emitted to the third optical fiber.

7. An optical fiber branching switching apparatus comprising:
a first optical fiber; a second optical fiber; a third optical fiber; a fourth optical fiber; a plurality of fifth optical fibers; a plurality of sixth optical fibers;
and a plurality of seventh optical fibers, wherein
the first optical fiber is connected to the second optical fiber by using a plurality of the fifth optical fibers,
the first optical fiber is connected to the third optical fiber by using a plurality of the sixth optical fibers, and
the second optical fiber is connected to the fourth optical fiber by using a plurality of the seventh optical fibers.

8. The optical fiber branching switching apparatus according to claim 7, wherein
the first optical fiber includes a first plurality of cores,
the second optical fiber includes a second plurality of cores,
the first plurality of cores are separated into a plurality of the fifth optical fibers and a plurality of the sixth optical fibers, and
the second plurality of cores are separated into a plurality of the fifth optical fibers and a plurality of the seventh optical fibers.

9. The optical fiber branching switching apparatus according to claim 7, wherein fan-in/fan-out is performed from the first optical fiber to a plurality of the fifth optical fibers and a plurality of the sixth optical fibers, fan-in/fan-out is performed from the second optical fiber to a plurality of the fifth optical fibers and a plurality of the seventh optical fibers, fan-in/fan-out is performed from the third optical fiber to a plurality of the sixth optical fibers, and fan-in/fan-out is performed from the fourth optical fiber to a plurality of the seventh optical fibers.

10. The optical fiber branching switching apparatus according to claim 7, further comprising:
a first switching apparatus; and a second switching apparatus,
wherein a plurality of the sixth optical fibers are connected to a plurality of the seventh optical fibers via the first switching apparatus and the second switching apparatus.

11. The optical fiber branching switching apparatus according to claim 10, wherein
the fifth optical fiber includes a line being incident from the second optical fiber and emitted to the first optical fiber,
the sixth optical fiber includes a line being incident from the first optical fiber and emitted to the third optical fiber, and
the seventh optical fiber includes a line being incident from the fourth optical fiber and emitted to the second optical fiber.

12. The optical fiber branching switching apparatus according to claim 10, wherein
a plurality of the fifth optical fibers include at least a line being incident from the first optical fiber and emitted to the second optical fiber, and a line being incident from the second optical fiber and emitted to the first optical fiber,
a plurality of the sixth optical fibers include at least a line being incident from the first optical fiber and emitted to the third optical fiber, and a line being incident from the third optical fiber and emitted to the first optical fiber,
a plurality of the seventh optical fibers include at least a line being incident from the second optical fiber and emitted to the fourth optical fiber, and a line being incident from the fourth optical fiber and emitted to the second optical fiber,
a line of the sixth optical fiber being incident from the first optical fiber and emitted to the third optical fiber is connected to a line of the seventh optical fiber being incident from the fourth optical fiber and emitted to the second optical fiber, and
a line of the sixth optical fiber being incident from the third optical fiber and emitted to the first optical fiber is connected to a line of the seventh optical fiber being incident from the second optical fiber and emitted to the fourth optical fiber.

13. An optical fiber branching switching apparatus comprising:
a first optical fiber including a first plurality of cores; a second optical fiber including a second plurality of cores; a third optical fiber including a third plurality of cores; a fourth optical fiber including a fourth plurality of cores;
a first switching apparatus; and a second switching apparatus, wherein
the first plurality of cores are connected to the third plurality of cores,
the second plurality of cores are connected to the fourth plurality of cores, and
the first plurality of cores are connected to the second plurality of cores via the first switching apparatus and the second switching apparatus.

14. The optical fiber branching switching apparatus according to claim 13, wherein the number of the first plurality of cores is equal to the number of the second plurality of cores.

15. The optical fiber branching switching apparatus according to claim 14, wherein the number of the first plurality of cores is four or more.

16. The optical fiber branching switching apparatus according to claim 13, wherein
the first plurality of cores include at least, with respect to the optical fiber branching switching apparatus, a line being incident to and a line being emitted from,
the second plurality of cores include at least, with respect to the optical fiber branching switching apparatus, a line being incident to and a line being emitted from,
a line of the first plurality of cores being incident to the optical fiber branching switching apparatus is connected to a line of the second plurality of cores being emitted from the optical fiber branching switching apparatus, and
a line of the first plurality of cores being emitted from the optical fiber branching switching apparatus is connected to a line of the second plurality of cores being incident to the optical fiber branching switching apparatus.
